(19) United States
(12) Patent Application Publication
(10) Pub. No.: US 2026/0220331 A1
(43) Pub. Date: Jul. 30, 2026

(54) Method for Manufacturing Target Object, Determination Apparatus, Computer Readable Storage Medium and Electronic Device

(71) Applicant: GUANGZHOU HEYGEARS IMC.INC, Guangzhou (CN)

(72) Inventors: Dongcheng FANG, Guangzhou (CN); Dehao DUAN, Guangzhou (CN); Miao DENG, Guangzhou (CN); Dongping LIU, Guangzhou (CN); Yusheng LI, Guangzhou (CN)

(73) Assignee: GUANGZHOU HEYGEARS IMC.INC, Guangzhou (CN)

(21) Appl. No.: 19/634,485

(22) Filed: Mar. 31, 2026

Related U.S. Application Data
(63) Continuation of application No. PCT/CN2024/135865, filed on Nov. 29, 2024.

(30) Foreign Application Priority Data
Dec. 29, 2023 (CN) 202311874154.9
Feb. 7, 2024 (CN) 202410175111.X

(51) Int. Cl. G06F 30/23; B33Y 10/00; B33Y 50/02; G06F 113/10; G06F 119/14

(52) U.S. Cl. CPC G06F 30/23; B33Y 10/00; B33Y 50/02; G06F 2113/10; G06F 2119/14

(57) ABSTRACT

A method for manufacturing a target object. The method includes: acquiring a data file and material property parameters of a printing model, the printing model being a three-dimensional model to be printed; generating an initial support model and a target finite element model comprising the initial support model according to the data file and the material property parameters; determining whether the target finite element model satisfies a stress intensity condition; in cases where the target finite element model does not satisfy the stress intensity condition, adjusting the initial support model in the target finite element model, so that the adjusted target finite element model satisfies the stress intensity condition, to obtain a target support model; and performing 3D printing on the printing model according to the target support model.

### CROSS-REFERENCE TO RELATED APPLICATION

The present disclosure is continuation application of International Application No. PCT/CN2024/135865 filed on Nov. 29, 2024, which claims priority to Chinese Patent application No. 202410175111.X to the China National Intellectual Property Administration on Feb. 7, 2024 and entitled “Method and Apparatus for Determining Supporting Data of Three-Dimensional Model, and Electronic Device,” and Chinese Patent application No. 202311874154.9 to the China National Intellectual Property Administration on Dec. 29, 2023 and entitled “Method and Apparatus for Determining Support model, Storage Medium, and Electronic Device,” the entire contents of each of which are incorporated herein by reference for all purposes.

### FIELD

The present disclosure relates to the technical field of optimization of 3D printing structures, and in particular, to a method for manufacturing a target object, a determination apparatus, a computer-readable storage medium, and an electronic device.

### BACKGROUND

3D printing is an additive manufacturing technology that manufactures three-dimensional objects by adding materials layer by layer, overcoming the limitations of traditional machining in creating complex structures and enabling simplified production of any complex structural component. Currently, 3D printing technologies are diversified, and the implementation details of the processes are also quite different. However, in a molding process, it is almost necessary to add an additional auxiliary support structure to improve the printing success rate of a model. Whether the design of a support model is reasonable, such as insufficient support, will directly affect the molding accuracy and the success rate of model printing.

With the maturity of the Computer Aided Engineering (CAE) technology for structural simulation and the development of the 3D printing technology, the research of solving the difficulty point of the 3D printing related technology on the basis of the mechanical simulation method gradually becomes a hot spot, and it is very efficient and meaningful to guide the design of the support model on the basis of the support mechanical performance simulation method in the digital light processing (DLP) 3D printing technology. Currently, there are various types of support models, such as tree-like, scaffold-like, and columnar types. However, they are almost all generated based on the geometric features of the model and practical experience, and there is currently a lack of accurate and reasonable evaluation methods.

At present, most support model designs adopt a method combining geometrical characteristic detection and experiences, that is, the position of a contact point of a support model is roughly determined by means of detection of a model printability feature, and then the density of the support is simply adjusted by means of a large number of 3D printing practices. For example, when an angle greater than 45° with the vertical plane is detected in the model contour, supports are provided on the inclined surface at equal intervals or according to a custom distribution, or manually based on empirical experiences.

Existing support determination methods rely solely on geometric analysis, adding supports by detecting printability-related geometric features of the model. Although some 3D printing practices have been incorporated for optimization, the method remains overly simplistic and fails to solve the problem from the fundamental perspective of structural performance. The support model generated by the method generally has problems such as unreasonable topology structures, structural redundancy, low molding efficiency, and poor molding accuracy.

In addition, when three-dimensional printing is performed, various complex three-dimensional objects are constructed under the constraint of gravitational force, and it is often necessary to create a structure starting from a position with the lowest gravitational potential energy to the direction opposite to the gravitational force. The fundamental reason is that local parts of the object cannot maintain their position under the constraint of gravity. In this case, a support structure capable of self-supporting construction from already fixed positions is needed to maintain the object's spatial position.

In the actual construction process, in addition to gravitational constraints, there are often more environmental constraints that affect the conditions for achieving self-support. Since supports are also three-dimensional objects, they are subject to internal material or physical stresses. Therefore, a support model capable of adapting to complex stress conditions is needed for application in the field of complex 3D printing.

In the existing technologies, support models are generally based on independent cylindrical shapes. However, the taller the cylinder, the less effective the radius of the cylinder becomes in resisting stress. There is a technical problem in the related art that when a three-dimensional model is printed according to three-dimensional printing data comprising support data, a support condition of the printed three-dimensional model is unstable.

In view of the above problems, no effective solution has been proposed.

### SUMMARY

An objective of embodiments of the present disclosure is to provide a method for manufacturing a target object, a determination apparatus, a computer readable storage medium and an electronic device, so as to at least solve a problem that the determined support model is unreasonable, causing the three-dimensional models to easily detach during a 3D printing process.

An objective of embodiments of the present disclosure is to provide a method and apparatus for determining support data of a three-dimensional model, and an electronic device, so as to at least solve the technical problem in the related art that when a three-dimensional model is printed according to three-dimensional printing data comprising support data, a support condition of the printed three-dimensional model is unstable.

### Technical Solution

The technical solutions adopted in the embodiments of the present disclosure are:
in order to achieve the first objective, a first aspect of the embodiments of the present disclosure provides a method for manufacturing a target object, comprising: acquiring a data file and material property parameters of a printing model, the printing model being a digital three-dimensional model of a target object to be printed; generating an initial support model and a target finite element model comprising the initial support model according to the data file and the material property parameters; determining whether the target finite element model satisfies a stress intensity condition; in cases where the target finite element model does not satisfy the stress intensity condition, adjusting the initial support model in the target finite element model, so that the adjusted target finite element model satisfies the stress intensity condition, to obtain a target support model; and performing 3D printing on the printing model according to the target support model, so as to obtain a physical object including the support structure and the printing model.

In some embodiments, generating an initial support model and a target finite element model comprising the initial support model according to the data file and the material property parameters comprises: generating, according to the data file and the material property parameters, a finite element model of the printing model to obtain a first finite element model; generating a parameterized file of the initial support model according to the data file, the initial support model being a structure supporting the printing model in a printing process; generating the finite element model of the initial support model according to the parameterized file, to obtain a second finite element model; and merging the first finite element model and the second finite element model according to the parameterized file, to obtain the target finite element model comprising the initial support model and the printing model.

In some embodiments, generating the finite element model of the initial support model according to the parameterized file, to obtain a second finite element model comprises: performing division and modeling on the initial support model according to the parameterized file, to obtain the second finite element model.

In some embodiments, merging the first finite element model and the second finite element model according to the parameterized file, to obtain the target finite element model comprising the initial support model and the printing model, comprises: determining position coordinates of a connection node between the initial support model and the printing model according to the parameterized file, to obtain contact position coordinates; determining a polyhedron unit closest to the connection node in the first finite element model according to the contact position coordinates, to obtain a target polyhedron unit; determining force coupling and transferring of the target polyhedron unit and the second finite element model using a multipoint constraint equation in a finite element method, to obtain an initial finite element model; and imposing a boundary constraint and a load constraint to the initial finite element model to obtain the target finite element model.

In some embodiments, determining the polyhedron unit closest to the connection node in the first finite element model according to the contact position coordinates to obtain the target polyhedron unit, comprises: determining a polyhedron unit closest to the connection node in the first finite element model according to the contact position coordinates and by means of an algorithm for constructing a k-d tree, to obtain a target polyhedron unit.

In some embodiments, determining whether the target finite element model satisfies the stress intensity condition, comprises: calculating the stresses of all the nodes in the target finite element model to obtain a target stress distribution, and calculating displacement of all the nodes in the target finite element model according to the data file to obtain a target displacement distribution, wherein the displacement deformation comprises a displacement amount of a node of the printing model relative to a corresponding node of the target finite element model, and a displacement amount of a node of the initial support model relative to a corresponding node in the target finite element model; and determining whether the target finite element model satisfies the stress intensity condition according to the target stress distribution and the target displacement distribution; and in cases where a stress of a node in the target finite element model is less than or equal to a yield stress of a material, determining that the node in the target finite element model satisfies the stress intensity condition.

In some embodiments, generating, according to the data file and the material property parameters, the finite element model of the printing model to obtain the first finite element model, comprises: performing meshing on the printing model according to the data file to obtain mesh model data; and constructing the finite element model of the printing model using polyhedron units according to the mesh model data and the material property parameters, to obtain the first finite element model.

In some embodiments, adjusting the initial support model in the target finite element model comprises: adding and deleting connecting rods in the initial support model in the target finite element model according to nodes not satisfying the stress intensity condition in the target finite element model.

In some embodiments, the parameterized file comprises support data corresponding to the three-dimensional model; generating the parameterized file of the initial support model according to the data file, the initial support model being a structure supporting the printing model in a printing process, comprises:
acquiring a three-dimensional model, the three-dimensional model being located in a voxel space formed by an X axis, a Y axis and a Z axis, the voxel space comprising a plurality of voxels; determining a target source voxel from the plurality of voxels; determining, in a negative direction of the Z axis, a target secondary voxel corresponding to the target source voxel; performing voxel type determination on the target secondary voxel, and determining a voxel type result of the target secondary voxel; and obtaining support data corresponding to the three-dimensional model according to the voxel type result.

In some embodiments, determining the target source voxel from the plurality of voxels comprises: acquiring a support point corresponding to the three-dimensional model; determining a target voxel vertex corresponding to the support point; and determining, from the plurality of voxels, a target source voxel relating to the target voxel vertex.

In some embodiments, obtaining support data corresponding to the three-dimensional model according to the voxel type result, comprises: determining a next-level voxel according to whether the voxel type result is a blocking voxel type, until a corresponding voxel with a Z coordinate being a baseplate coordinate is determined, so as to obtain the support data corresponding to the three-dimensional model.

In some embodiments, determining the next-level voxel according to whether the voxel type result is the blocking voxel type, until the corresponding voxel with the Z coordinate being the baseplate coordinate is determined, so as to obtain the support data corresponding to the three-dimensional model, comprises: in cases where the voxel type of the target secondary voxel is the blocking voxel type, determining a target adjacent voxel corresponding to the target secondary voxel, wherein a Z coordinate of the target adjacent voxel is the same as a Z coordinate of the target secondary voxel; and determining the next-level voxel by taking the target adjacent voxel as a new source voxel, until a corresponding voxel with a Z coordinate being a baseplate coordinate is determined, so as to obtain the support data, wherein the baseplate coordinate is a minimum coordinate of the three-dimensional model in the direction of the Z axis.

In some embodiments, determining a target adjacent voxel corresponding to the target secondary voxel comprises: determining at least one candidate adjacent voxel corresponding to the target secondary voxel, wherein a Z coordinate of the at least one candidate adjacent voxel is the same as a Z coordinate of the target secondary voxel, and the distance between the at least one candidate adjacent voxel and the target secondary voxel is less than a first predetermined threshold; and determining the target adjacent voxel from the at least one candidate adjacent voxel.

In some embodiments, determining the next-level voxel according to whether the voxel type result is the blocking voxel type, until the corresponding voxel with the Z coordinate being the baseplate coordinate is determined, so as to obtain the support data corresponding to the three-dimensional model, comprises: in cases where the voxel type of the target secondary voxel is not the blocking voxel type, determining a voxel directly below the target secondary voxel as the next-level voxel, until a corresponding voxel with a Z coordinate being a baseplate coordinate is determined, so as to obtain the support data.

In some embodiments, before determining the next-level voxel according to whether the voxel type result is the blocking voxel type, until the corresponding voxel with the Z coordinate being the baseplate coordinate is determined, so as to obtain support data corresponding to the three-dimensional model, the method further comprises: in cases where the support point include a support point on an outer surface of the three-dimensional model and a support point on an inner surface of the three-dimensional, and the baseplate coordinate comprises a first baseplate coordinate and a second baseplate coordinate, determining the first baseplate coordinate corresponding to the support point on the outer surface of the three-dimensional model, and determining the second baseplate coordinate corresponding to the support point on the inner surface of the three-dimensional model, wherein the first baseplate coordinate is a minimum coordinate of the three-dimensional model in the Z-axis direction, and the second baseplate coordinate is a minimum coordinate of an inner hollowed-out portion of the three-dimensional model in the Z-axis direction.

In some embodiments, determining the target voxel vertex corresponding to the support point comprises: determining at least one candidate voxel vertex corresponding to the support point, wherein the distance between the candidate voxel vertex and the support point is less than a second predetermined threshold; and determining the target voxel vertex from the at least one candidate voxel vertex.

In some embodiments, determining the target voxel vertex from the at least one candidate voxel vertex comprises: determining the number of supports relating to every one of the at least one candidate voxel vertex is supported; and determining the target voxel vertex from the at least one candidate voxel vertex according to the number of supports relating to every one of the at least one candidate voxel vertex is supported.

In some embodiments, determining the target voxel vertex from the at least one candidate voxel vertex comprises: determining the connection parameters for at least one connecting rod connecting the candidate voxel vertex to the support point; and determining the target voxel vertex from the at least one candidate voxel vertex according to the connection parameters for at least one connecting rod connecting the candidate voxel vertex to the support points.

In some embodiments, determining, from the plurality of voxels, the target source voxel relating to the target voxel vertex comprises: determining, from the plurality of voxels, at least one candidate source voxel relating to the target voxel vertex, wherein a Z coordinate of the at least one candidate source voxel is less than or equal to the Z coordinate of to the target voxel vertex; and determining the target source voxel from the at least one candidate source voxel.

In some embodiments, after determining the target source voxel from the plurality of voxels, the method further comprises: determining whether a target secondary voxel corresponding to the target source voxel exists in a negative direction of the Z axis; and in cases where the target secondary voxel corresponding to the target source voxel doesn't exist, determining data of a connecting rod connecting the support point to a predetermined surface.

In some embodiments, a shape of a connecting rod represented by the connecting rod data is hemispherical at both ends and cylindrical in the middle.

In some embodiments, the support point and the target voxel vertex corresponding to the target voxel data are connected to each other by a conical frustum connector, the conical frustum connector comprises a tip and a bottom surface, the tip is connected to the support point, and the bottom surface is connected to the target voxel vertex corresponding to the target voxel data.

In some embodiments, a radius of the bottom surface is equal to a cylindrical radius corresponding to the target voxel data.

In some embodiments, the voxel is a hollow voxel, and a target surface of the voxel is formed by two cylinders intersecting diagonally.

In some embodiments, a resolution of the voxel is greater than a radius of the cylinder by a predetermined multiple.

In some embodiments, the radius of the cylinder is determined according to a distance between the corresponding voxel and the three-dimensional model and a collision probability corresponding to the distance.

A second aspect of the embodiments of the present disclosure provides an apparatus for manufacturing a target object, comprising: an acquisition unit, configured to acquire a data file and material property parameters of a printing model, the printing model being a three-dimensional model to be printed; a generation unit, configured to generate an initial support model and a target finite element model comprising the initial support model according to the data file and the material property parameters; a determination unit, configured to determine whether the target finite element model satisfies a stress intensity condition; an adjustment unit, configured to adjust, in cases where the target finite element model does not satisfy the stress intensity condition, the initial support model in the target finite element model, so that the adjusted target finite element model satisfies the stress intensity condition, to obtain a target support model; and a printing unit, configured to perform 3D printing on the printing model according to the target support model.

In some embodiments, the generation unit comprises: a first generation sub-unit, configured to generate, according to the data file and the material property parameters, a finite element model of the printing model to obtain a first finite element model; a second generation sub-unit, configured to generate a parameterized file of the initial support model according to the data file, the initial support model being a structure supporting the printing model in a printing process; a third generation sub-unit, configured to generate a finite element model of the initial support model according to the parameterized file, to obtain a second finite element model; and a merging sub-unit, configured to merge the first finite element model and the second finite element model according to the parameterized file, to obtain the target finite element model comprising the initial support model and the printing model.

A third aspect of the embodiments of the present disclosure provides a computer-readable storage medium, wherein the computer-readable storage medium comprises a stored program; and when the program runs, the computer-readable storage medium is controlled to execute any method for manufacturing a target object.

A fourth aspect of the embodiments of the present disclosure provides an electronic device, comprising: one or more processors, a memory, and one or more programs, wherein the one or more programs are stored in the memory and configured to be executed by the one or more processors, and the one or more programs include a method for executing any one of the methods for manufacturing a target object.

In order to achieve the second objective, a fifth aspect of the embodiments of the present disclosure provides a method for determining support data of a three-dimensional model, comprising: acquiring a three-dimensional model, wherein the three-dimensional model is located in a voxel space formed by an X axis, a Y axis and a Z axis, the voxel space comprising a plurality of voxels; determining a target source voxel from the plurality of voxels; determining, in a negative direction of the Z axis, a target secondary voxel corresponding to the target source voxel; performing voxel type determination on the target secondary voxel, and determining a voxel type result of the target secondary voxel; and obtaining support data corresponding to the three-dimensional model according to the voxel type result.

In some embodiments, determining the target source voxel from the plurality of voxels comprises: acquiring a support point corresponding to the three-dimensional model; determining a target voxel vertex corresponding to the support point; and determining, from the plurality of voxels, a target source voxel relating to the target voxel vertex.

In some embodiments, obtaining the support data corresponding to the three-dimensional model according to the voxel type result, comprises: determining a next-level voxel according to whether the voxel type result is a blocking voxel type, until a corresponding voxel with a Z coordinate being a baseplate coordinate is determined, so as to obtain the support data corresponding to the three-dimensional model.

In some embodiments, determining the next-level voxel according to whether the voxel type result is the blocking voxel type, until the corresponding voxel with the Z coordinate being the baseplate coordinate is determined, so as to obtain the support data corresponding to the three-dimensional model, comprises: in cases where the voxel type of the target secondary voxel is the blocking voxel type, determining a target adjacent voxel corresponding to the target secondary voxel, wherein a Z coordinate of the target adjacent voxel is the same as a Z coordinate of the target secondary voxel; and determining the next-level voxel by taking the target adjacent voxel as a new source voxel, until a corresponding voxel with a Z coordinate being a baseplate coordinate is determined, so as to obtain the support data, wherein the baseplate coordinate is a minimum coordinate of the three-dimensional model in the direction of the Z axis.

In some embodiments, determining the target adjacent voxel corresponding to the target secondary voxel comprises: determining at least one candidate adjacent voxel corresponding to the target secondary voxel, wherein a Z coordinate of the at least one candidate adjacent voxel is the same as a Z coordinate of the target secondary voxel, and a distance between the at least one candidate adjacent voxel and the target secondary voxel is less than a first predetermined threshold; and determining the target adjacent voxel from the at least one candidate adjacent voxel.

In some embodiments, determining the next-level voxel according to whether the voxel type result is a blocking voxel type, until a corresponding voxel with a Z coordinate being a baseplate coordinate is determined, so as to obtain the support data corresponding to the three-dimensional model, comprises: in cases where the voxel type of the target secondary voxel is not the blocking voxel type, determining a voxel directly below the target secondary voxel as the next-level voxel, until the corresponding voxel with the Z coordinate being a baseplate coordinate is determined, so as to obtain the support data.

In some embodiments, before determining the next-level voxel according to whether the voxel type result is the blocking voxel type, until the corresponding voxel with the Z coordinate being the baseplate coordinate is determined, so as to obtain the support data corresponding to the three-dimensional model, the method further comprises: in cases where the support point include a support point on an outer surface of the three-dimensional model and a support point on an inner surface of the three-dimensional model, and the baseplate coordinate comprises a first baseplate coordinate and a second baseplate coordinate, determining the first baseplate coordinate corresponding to the support point on the outer surface of the three-dimensional model, and determining the second baseplate coordinate corresponding to the support point on the inner surface of the three-dimensional model, wherein the first baseplate coordinate is a minimum coordinate of the three-dimensional model in the Z-axis direction, and the second baseplate coordinate is a minimum coordinate of an inner hollowed-out portion of the three-dimensional model in the Z-axis direction.

In some embodiments, determining the target voxel vertex corresponding to the support point comprises: determining at least one candidate voxel vertex corresponding to the support point, wherein the distance between the candidate voxel vertex and the support point is less than a second predetermined threshold; and determining the target voxel vertex from the at least one candidate voxel vertex.

In some embodiments, determining the target voxel vertex from the at least one candidate voxel vertex comprises: determining the number of supports relating to every one of the at least one candidate voxel vertex is supported; and determining the target voxel vertex from the at least one candidate voxel vertex according to the number of supports relating to every one of the at least one candidate voxel vertex is supported.

In some embodiments, determining the target voxel vertex from the at least one candidate voxel vertex comprises: determining the connection parameters for at least one connecting rod connecting the candidate voxel vertex to the support point; and determining the target voxel vertex from the at least one candidate voxel vertex according to the connection parameters for at least one connecting rod connecting the candidate voxel vertex to the support point.

In some embodiments, determining, from the plurality of voxels, the target source voxel relating to the target voxel vertex comprises: determining, from the plurality of voxels, at least one candidate source voxel relating to the target voxel vertex, wherein a Z coordinate of the at least one candidate source voxel is less than or equal to the Z coordinate of the target voxel vertex; and determining the target source voxel from the at least one candidate source voxel.

In some embodiments, after determining the target source voxel from the plurality of voxels, the method further comprises: determining whether a target secondary voxel corresponding to the target source voxel exists in a negative direction of the Z axis; and in cases where the target secondary voxel corresponding to the target source voxel doesn't exist, determining data of a connecting rod connecting the support point to the predetermined surface.

In some embodiments, a shape of a connecting rod represented by the connecting rod data is hemispherical at both ends and cylindrical in the middle.

In some embodiments, the support point and the target voxel vertex corresponding to the target voxel data are connected to each other by a conical frustum connector, the conical frustum connector comprises a tip and a bottom surface, the sharp point is connected to the support point, and the bottom surface is connected to the target voxel vertex corresponding to the target voxel data.

In some embodiments, a radius of the bottom surface is equal to a cylindrical radius corresponding to the target voxel data.

In some embodiments, the voxel is a hollow voxel, and a target surface of the voxel is formed by two cylinders intersecting diagonally.

In some embodiments, a resolution of the voxel is greater than a radius of the cylinder by a predetermined multiple.

In some embodiments, the radius of the cylinder is determined according to a distance between the corresponding voxel and the three-dimensional model and a collision probability corresponding to the distance.

A sixth aspect of the embodiments of the present disclosure provides an apparatus for determining support data of a three-dimensional model, comprising: a first acquisition module, configured to acquire a three-dimensional model, wherein the three-dimensional model is located in a voxel space formed by an X axis, a Y axis and a Z axis, the voxel space comprising a plurality of voxels; a first determination module, configured to determine a target source voxel from the plurality of voxels; a second determination module, configured to determine, in a negative direction of the Z axis, a target secondary voxel corresponding to the target source voxel; a third determination module, configured to perform voxel type determination on the target secondary voxel, and determine a voxel type result of the target secondary voxel; and a fourth determination module, configured to obtain support data corresponding to the three-dimensional model according to the voxel type result.

A seventh aspect of the embodiments of the present disclosure provides an electronic device, comprising: a processor; a memory for storing processor executable instructions; wherein the processor is configured to execute instructions to implement any one of the methods for determining support data of a three-dimensional model.

An eighth aspect of the embodiments of the present disclosure provides a computer-readable storage medium, wherein when instructions in the computer-readable storage medium are executed by a processor of an electronic device, the electronic device is caused to execute any one of the methods for determining support data of a three-dimensional model.

### Beneficial Effects

The beneficial effects of the first aspect provided by the embodiments of the present disclosure lie in applying the technical solutions of the present disclosure: firstly acquiring a data file and material property parameters of a three-dimensional model to be printed; then generating an initial support model and a target finite element model comprising the initial support model according to the data file and the material property parameters; then determining whether the target finite element model satisfies a stress intensity condition; in cases where the target finite element model does not satisfy the stress intensity condition, adjusting the initial support model in the target finite element model, so that the adjusted target finite element model satisfies the stress intensity condition, to obtain a target support model; and finally performing 3D printing on the printing model according to the target support model. Compared with the related art, where support models are often unreasonably designed due to the difficulty of efficient and accurate analysis, leading to various problems during the 3D printing process, the present disclosure generates an initial support model and a target finite element model comprising the initial support model on the basis of the data file and material property parameters of the printing model, then determines whether the target finite element model meets the stress intensity requirements, if not, adjusts the initial support model in the target finite element model, so as to ensures that obtained support model is good. In other words, the present disclosure can guide the design of the support model by the actual stress result of the model and the support, and determine whether the design of the support model is reasonable and whether the support model is strong enough to support the model, so as to ensure successful model printing, thereby avoiding problems such as model detachment caused by an unreasonable support structure during 3D printing, ensuring that the model remains properly fixed, and effectively improving model deformation due to insufficient support structure, and guaranteeing high accuracy in the final printed 3D model. In addition, by means of the technical solution of the present disclosure, while reasonably designing a support model, it can be determined whether there is a redundant support model, thereby reducing redundant support models in a model, thereby reducing the consumption of printing materials and saving costs.

The beneficial effects of the second aspect provided by the embodiments of the present disclosure lie in: in the embodiments of the present disclosure, acquiring a three-dimensional model, the three-dimensional model being located in a voxel space formed by an X axis, a Y axis and a Z axis, the voxel space comprising a plurality of voxels; determining a target source voxel from the plurality of voxels; determining, in a negative direction of the Z axis, a target secondary voxel corresponding to the target source voxel; performing voxel type determination on the target secondary voxel, and determining a voxel type result of the target secondary voxel; and obtaining the support data corresponding to the three-dimensional model according to the voxel type result. By means of the described steps, a voxel for supporting is determined level by level, so as to obtain support data; a support is added to a three-dimensional model according to the support data; after the addition of a support is completed, printing data of the three-dimensional model is generated; and the three-dimensional model is printed according to the printing data of the three-dimensional model. By means of the method, when a three-dimensional model is printed according to printing data, the support condition of the printed three-dimensional model is more stable, thereby solving the technical problem in the related art that when a three-dimensional model is printed according to three-dimensional printing data comprising support data, the support condition of the printed three-dimensional model is unstable.

### BRIEF DESCRIPTION OF THE DRAWINGS

To describe the technical solutions in the embodiments of the present disclosure more clearly, the following briefly describes the accompanying drawings required for describing the embodiments or exemplary technologies. Apparently, the accompanying drawings in the following description show merely some embodiments of the present disclosure, and a person of ordinary skill in the art may still derive other accompanying drawings from these accompanying drawings without creative efforts.

FIG. 1 shows a structural block diagram of hardware of a mobile terminal for executing a method for manufacturing a target object according to an embodiment of the present disclosure;

FIG. 2 shows a schematic flowchart of a method for manufacturing a target object according to an embodiment of the present disclosure;

FIG. 3 shows a schematic flowchart of merging a first finite element model and a second finite element model according to an embodiment of the present disclosure;

FIG. 4 shows a schematic diagram of a photocuring process for DLP 3D printing according to an embodiment of the present disclosure;

FIG. 5 shows a target displacement distribution result diagram of a mechanical simulation of a printing model and an initial support model according to an embodiment of the present disclosure;

FIG. 6 shows a target stress distribution result diagram of a mechanical simulation of a printing model and an initial support model according to an embodiment of the present disclosure;

FIG. 7 shows a schematic flowchart of a specific method for manufacturing a target object according to an embodiment of the present disclosure;

FIG. 8 shows a structural block diagram of an apparatus for manufacturing a target object according to an embodiment of the present disclosure;

FIG. 9 is a flowchart of a method for determining support data of a three-dimensional model according to an embodiment of the present disclosure;

FIG. 10 is a schematic diagram of a model according to an optional implementation of the present disclosure;

FIG. 11 is a schematic diagram of a part of a flowing voxel waterfall (support model) of an outer surface of a model according to an optional implementation of the present disclosure;

FIG. 12 is a schematic diagram of a flowing voxel waterfall on an outer surface of a model according to an optional implementation of the present disclosure;

FIG. 13 is a schematic diagram of a local flowing voxel waterfall on an outer surface of a model according to an optional implementation of the present disclosure;

FIG. 14 is a schematic diagram of a local flow voxel waterfall within a model according to an optional implementation of the present disclosure;

FIG. 15 is a schematic diagram of a relationship between a support point and a voxel according to an optional implementation of the present disclosure;

FIG. 16 is a schematic diagram of corresponding supported times of voxels according to an optional implementation of the present disclosure;

FIG. 17 is a schematic diagram illustrating the direction of a voxel when the voxel type of the target secondary voxel is a blocking voxel type according to an optional implementation of the present disclosure;

FIG. 18 is a schematic diagram of a connector connected to the surface of an object according to an optional implementation of the present disclosure;

FIG. 19 is a comparison diagram between simplified voxel data and non-simplified voxel data according to an optional implementation of the present disclosure;

FIG. 20 is a comparison diagram between simplified model overall voxel data and non-simplified model overall voxel data according to an optional implementation of the present disclosure;

FIG. 21 is a schematic diagram of simplification and non-simplification of voxel data of the printing data according to an optional implementation of the present disclosure;

FIG. 22 is an overlapping comparison diagram of voxel data according to an optional implementation of the present disclosure;

FIG. 23 is a schematic diagram of connector components according to an optional implementation of the present disclosure;

FIG. 24 is a comparison diagram when the resolutions of voxels are different according to an optional implementation of the present disclosure;

FIG. 25 is a schematic cross-sectional diagram when the voxel resolution is equal to eight times the radius of the cylinder according to an optional implementation of the present disclosure;

FIG. 26 is a schematic diagram that includes a conical frustum connector according to an optional implementation of the present disclosure;

FIG. 27 is a schematic diagram that includes another conical frustum connector according to an optional implementation of the present disclosure;

FIG. 28 is a schematic diagram that labels a conical frustum connector according to an optional implementation of the present disclosure;

FIG. 29 is a schematic diagram of a connector according to an optional implementation of the present disclosure;

FIG. 30 is a top view of a mold according to an optional implementation of the present disclosure;

FIG. 31 is a schematic diagram of a base according to an optional implementation of the present disclosure;

FIG. 32 is a structural block diagram of an apparatus for determining support data of a three-dimensional model according to an embodiment of the present disclosure;

The drawings include the following reference signs:

102: processor; 104: memory; 106: transmission device; 108: input/output device; 11: printer cover; 12: forming platform; 13: Z-axis assembly; 14: material tray; 15: protection glass; 16: light shield.

### DETAILED DESCRIPTION OF THE EMBODIMENTS

It should be noted that the embodiments in the disclosure and features in the embodiments can be combined without conflicts. The disclosure will be described below in detail with reference to the drawings and in combination with the embodiments.

In order to make the solutions of the application better understood by those skilled in the art, the technical solutions in the embodiments of the application will be clearly and completely described below in combination with the drawings in the embodiments of the application. It is apparent that the described embodiments are not all embodiments but part of embodiments of the application. All other embodiments obtained by those of ordinary skill in the art on the basis of the embodiments in the present disclosure without creative work shall fall within the scope of protection of the present disclosure.

It should be noted that the terms “first”, “second” etc., in the description, claims, and accompanying drawings of the present disclosure are used to distinguish similar objects, and are not necessarily used to describe a specific sequence or order. It should be understood that the data so used may be interchanged where appropriate, so that the embodiments of the present disclosure described herein can be achieved. In addition, the terms “comprising”, “having” or other variants aim to cover non-exclusive inclusion, such that the processes, methods, systems, articles or devices comprising a series of steps or units not only include those steps or units, but also include other factors not listed explicitly, or further include steps or units intrinsic for such processes, methods, articles or devices.

As introduced in the background art, a support model determined in the related art is unreasonable, so that a three-dimensional model easily detaches in a 3D printing process. To solve the foregoing problem, embodiments of the present disclosure provide a method for manufacturing a target object, a determination apparatus, a computer readable storage medium, and an electronic device.

Terms appearing in the present disclosure are introduced below:
pwf: pixel waterfall, which is a nickname of the support involved in the present disclosure, and is similar to a scaffold-like support.

The technical solutions in the embodiments of the present disclosure will be clearly and completely described below with reference to the accompanying drawings in the embodiments of the present disclosure.

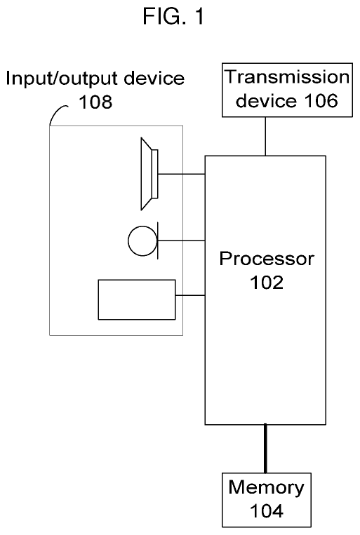

The method embodiment provided in the embodiment of the present disclosure may be executed in a mobile terminal, a computer terminal, or a similar computing device. By taking running on a mobile terminal as an example, FIG. 1 is a hardware structure block diagram of a mobile terminal for executing a method for manufacturing a target object according to an embodiment of the present disclosure. As shown in FIG. 1, the mobile terminal may include one or more (only one is shown in FIG. 1) processors 102 (the processors 102 may include, but are not limited to, a microprocessor MCU or a processing device such as a Field Programmable Gate Array (FPGA)) and a memory 104 configured to store data, wherein the mobile terminal may further include a transmission device 106 for a communication function and an input/output device 108. Those ordinarily skilled in the art can appreciate that the structure shown in FIG. 1 is for illustrative purposes only, but not limit the structure of the mobile terminal. For example, the mobile terminal may also include more or fewer components than that shown in FIG. 1, or have a different configuration than that shown in FIG. 1.

The memory 104 may be configured to store a computer program, for example, a software program and a module of application software, such as a computer program corresponding to the method for manufacturing the target object in the embodiment of the present disclosure. The processor 102 runs the computer program stored in the memory 104, so as to execute various function applications and data processing, that is, to implement the foregoing method. The memory 104 may include a high-speed random access memory, and may also include a non-transitory memory, such as one or more magnetic storage apparatuses, flash memories, or other non-transitory solid-state memories. In some instances, the memory 104 may further include memories remotely arranged with respect to the processor 102, and these remote memories may be connected to the mobile terminal over a network. Examples of the described network include, but are not limited to the Internet, an intranet, a local area network, a mobile communication network, and a combination thereof. The transmission device 106 is configured to receive or transmit data over a network. Specific examples of the described network may include a wireless network provided by a communication provider of the mobile terminal. In one example, the transmission device 106 comprises a Network Interface Controller (NIC) which may be connected to other network devices by means of a base station, thereby being able to communicate with the Internet. In one example, the transmission device 106 may be a Radio Frequency (RF) module for communicating wirelessly with the Internet.

In the present embodiment, a method for manufacturing a target object that runs on a mobile terminal, a computer terminal, or a similar computing apparatus is provided. It should be noted that the steps shown in the flowchart of the drawings may be executed in a computer system such as a set of computer executable instructions. Although the logic order is shown in the flowchart, in some cases, the shown or described steps can be executed in an order different from that described here.

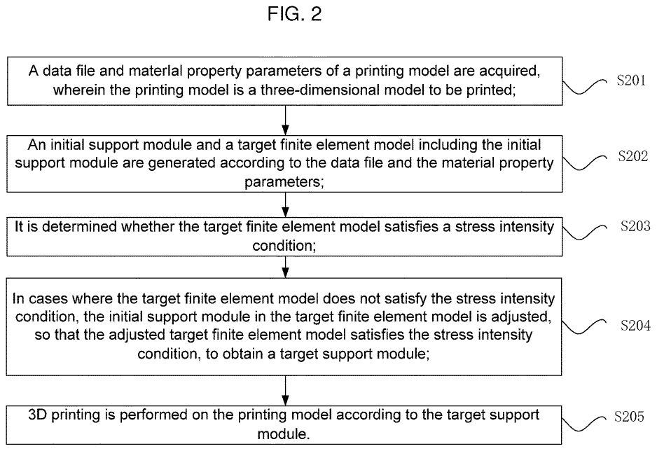

FIG. 2 is a flowchart of a method for manufacturing a target object according to an embodiment of the present disclosure. As shown in FIG. 2, the method comprises the following steps:
step S201: a data file and material property parameters of a printing model are acquired, wherein the printing model is a three-dimensional model to be printed.

As an alternative embodiment, the data file may be in a StereoLithography (STL) data format, and may also be in another data format, which depends on a calculation program of the simulation analysis, and is not specifically limited in the present disclosure.

As an alternative embodiment, for DLP 3D printing technology, although the support structures and the photopolymer resin of the model are not 100% fully photocured during the actual molding process, considering the complexity of the resin material, the material properties of the fully photocured photopolymer resin may be used approximately. Later, detailed adjustments may be made through strict testing and comparison. Considering the current application scenario, a linear static simulation analysis method may be used for approximate analysis. In linear static simulation analysis, the elastic modulus and Poisson's ratio are the physical property parameters that determine the material stress and strain of the model in the stress condition. Taking gravity into account, the density parameters need to be provided. Thus, the material property parameters include, but are not limited to, the elastic modulus, Poisson's ratio and density of the resin.

Step S202: an initial support model and a target finite element model comprising the initial support model are generated according to the data file and the material property parameters.

As an alternative embodiment, the initial support model may be generated from the geometric characteristics of the model printability and extensive 3D printing practical experience.

Step S203: whether the target finite element model satisfies a stress intensity condition is determined.

Step S204: in cases where the target finite element model does not satisfy the stress intensity condition, the initial support model in the target finite element model is adjusted, so that the adjusted target finite element model satisfies the stress intensity condition, to obtain a target support model.

Step S205: 3D printing is performed on the printing model according to the target support model.

According to the described embodiments, a data file and material property parameters of a three-dimensional model to be printed are first acquired; then an initial support model and a target finite element model comprising the initial support model are generated according to the data file and the material property parameters; then whether the target finite element model satisfies a stress intensity condition is determined; in cases where the target finite element model does not satisfy the stress intensity condition, the initial support model in the target finite element model is adjusted, so that the adjusted target finite element model satisfies the stress intensity condition, to obtain a target support model; and finally 3D printing is performed on the printing model according to the target support model. Compared with the related art, where support models are often unreasonably designed due to the difficulty of efficient and accurate analysis, leading to various problems during the 3D printing process, the present disclosure generates an initial support model and a target finite element model comprising the initial support model on the basis of the data file and material property parameters of the printing model, then determines whether the target finite element model meets the stress intensity requirements, if not, adjusts the initial support model in the target finite element model, so as to ensures that obtained support model is good. In other words, the present disclosure can guide the design of the support model by the actual stress result of the model and the support, and determine whether the design of the support model is reasonable and whether the support model is strong enough to support the model, so as to ensure successful model printing, thereby avoiding problems such as model detachment caused by an unreasonable support structure during 3D printing, ensuring that the 3D model remains properly fixed, and effectively improving model deformation due to insufficient support structure, and guaranteeing high accuracy in the final printed 3D model. In addition, by means of the technical solution of the present disclosure, while reasonably designing a support model, it can be determined whether there is a redundant support model, thereby reducing redundant support models in a model, thereby reducing the consumption of printing materials and saving costs.

In an optional solution, the generating an initial support model and a target finite element model comprising the initial support model according to the data file and the material property parameters comprises: generating, according to the data file and the material property parameters, a finite element model of the printing model to obtain a first finite element model; generating a parameterized file of the initial support model according to the data file, the initial support model being a structure supporting the printing model in a printing process; generating the finite element model of the initial support model according to the parameterized file, to obtain a second finite element model; and merging the first finite element model and the second finite element model according to the parameterized file, to obtain the target finite element model comprising the initial support model and the printing model. In the present embodiment, by separately establishing the finite element model of the printing model and the finite element model of the initial support model, then merging the first finite element model and the second finite element model to obtain a target finite element model, it ensures that the obtained target finite element model is relatively adaptive, and prepares for subsequently determining whether the target finite element model satisfies a stress intensity condition, thereby further ensuring that a target support model obtained subsequently is superior, and further ensuring high precision of a three-dimensional model that is finally printed, and further reducing the consumption of the subsequent printing materials.

As an alternative embodiment, the parameterized file comprises files representing the geometric characteristics of the initial support model and a connection relationship between the initial support model and the printing model.

As an alternative embodiment, the parameterized file comprises data information such as a connection relationship of the initial support model, the positions of connection nodes inside the initial support model, the positions of connection nodes between the initial support model and the printing model, and the sectional shape and size of a support rod between any two connection points of the initial support model.

In other embodiments, generating the finite element model of the initial support model according to the parameterized file, to obtain a second finite element model comprises: performing division and modeling on the initial support model according to the parameterized file, to obtain the second finite element model. In the present embodiment, the initial support model is divided and modeled, which ensures that the process of generating the second finite element model is relatively simple and efficient, and ensures that the process of subsequently merging the first finite element model and the second finite element model is relatively simple and convenient.

In practical application, considering that the initial support model has an elongated beam feature, a one-dimensional Euler-Bernoulli beam element may be used to perform rapid simplified modeling. Certainly, those skilled in the art may also use other unit division manners to perform division modeling, such as a one-dimensional bar unit, which is not specifically limited in the present disclosure. In practice, it is only necessary to complete the calculation of the element stiffness of the initial support model.

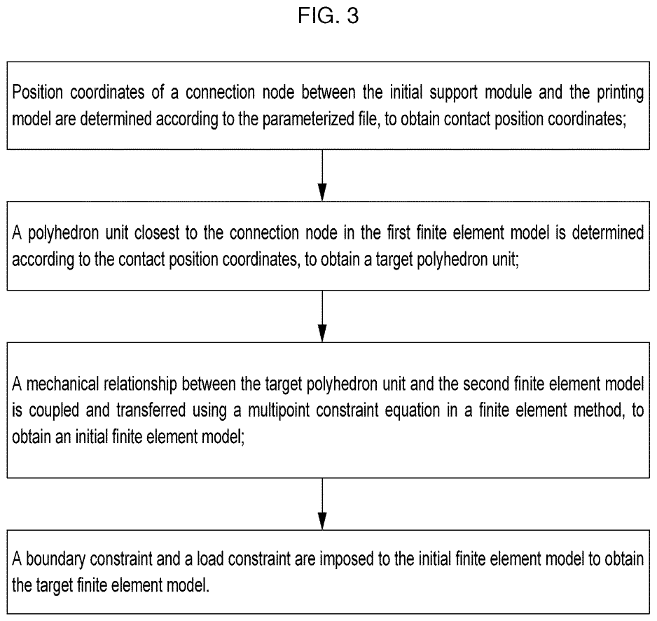

In other embodiments, generating the finite element model of the initial support model according to the parameterized file, to obtain a second finite element model comprises: as shown in FIG. 3, determining, according to the parameterized file, position coordinates of connection nodes between the initial support model and the printing model, to obtain contact position coordinates; determining a polyhedron unit closest to the connection node in the first finite element model according to the contact position coordinates, to obtain a target polyhedron unit; determining force coupling and transferring of the target polyhedron unit and the second finite element model using a multipoint constraint equation in a finite element method, to obtain an initial finite element model; and imposing a boundary constraint and a load constraint to the initial finite element model to obtain the target finite element model. In the present embodiment, the position coordinates of the connection node between the initial support model and the printing model are determined first; then according to the position coordinates, a polyhedral unit, which is closest to the connection node in the first finite element model, is determined; force coupling and transferring of the target polyhedron unit and the second finite element model is determined using a multipoint constraint equation; finally, a boundary constraint and a load constraint are applied to obtain the target finite element model, which ensures a well-matching between the first finite element unit and the second finite element unit during merging process, i.e. it is ensured that the compatibility is superior, which further ensures that the deformation of the printing model is more real and reasonable, and the target finite element model can be superior analyzed and adjusted subsequently.

As an alternative embodiment, the foregoing polyhedron unit may be a tetrahedron unit, a hexahedron unit, or another polyhedron unit, and is specifically determined according to a meshing manner performed on the printing model in the process of generating the first finite element model.

As an alternative embodiment, the multipoint constraint equation in the finite element method may be a linear relationship equation established between the degrees of freedom of different meshes or different units, so as to achieve mutual coupling and transfer of physical field information between the degrees of freedom of different models or different degrees of freedom of the same model. The multipoint constraint equation is a constraint relationship between two degrees of freedom. The degree of freedom is an unknown quantity for computing model unit nodes in the finite element analysis; each node in a polyhedron unit in the first finite element model contains three degrees of freedom; the degree of freedom of displacement (Uₓ U_{y} U_{z}) in three directions; and each node in the one-dimensional beam element in the second finite element model contains six degrees of freedom, i.e. the degree of freedom of displacement in three directions (Uₓ U_{y} U_{z}), and the degree of freedom of rotation in three directions (Rotₓ Rot_{y} Rot_{z}).

As an alternative embodiment, the boundary constraint is a type of constraint for a specified degree of freedom of a specified node in a finite element simulation analysis model, for example, completely fixed, i.e. the displacements in three directions are zero (Uₓ=U_{y}=U_{z}=0), and the rotations in three directions are also zero (Rotₓ=Rot_{y}=Rot_{z}=0). The load constraint is a load condition that the model needs to bear in the finite element simulation analysis model, has a plurality of types, such as a concentrated force, a volume force or a distributed force, and generally has a load constraint such as gravity.

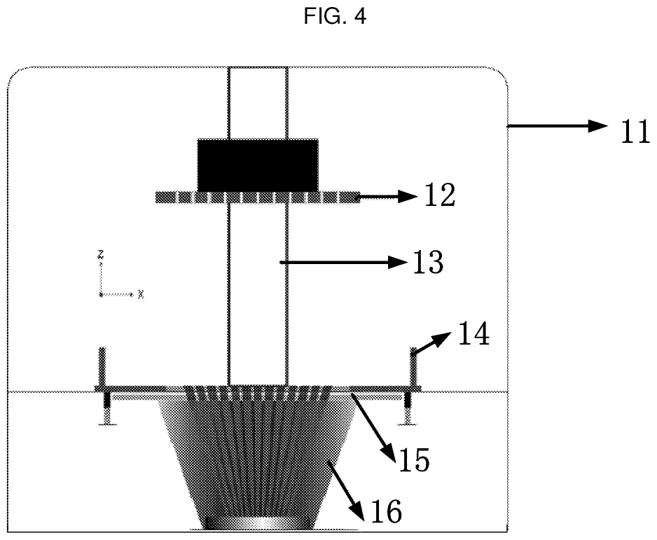

FIG. 4 is a schematic diagram of a photocuring process principle of DLP 3D printing in the present disclosure. As shown in FIG. 4, in the 3D printing process, the required devices include, but are not limited to, a printer cover 11, a forming platform 12, a Z-axis assembly 13, a material tray 14, protection glass 15 and a light shield 16.

As an alternative embodiment, during the 3D printing process, the bottom portion of the support structure is completely fixed to the forming platform. As the lifting mechanism of the DLP printer moves up and down at a slow speed, the dynamic effect may be ignored. This means a fixing constraint is imposed on the bottom portion of the initial support model in the initial finite element model. There are two main load constraints, one is the model weight itself, and the other is the peeling force between each layer of the liquid resin after being photocured and the material tray in the forming process of the DLP 3D process. Since the peeling force is mainly due to the size of the slicing area, the calculation relationship thereof is obtained through a lot of internal tests and summaries.

According to some exemplary embodiments of the present disclosure, determining the polyhedron unit closest to the connection node in the first finite element model according to the contact position coordinates to obtain the target polyhedron unit, comprises: determining a polyhedron unit closest to the connection node in the first finite element model according to the contact position coordinates and by means of an algorithm for constructing a k-d tree, to obtain a target polyhedron unit. In the present embodiment, an algorithm for constructing a k-d tree is used to determine a polyhedron unit closest to a connection node in a first finite element model, since the k-d tree may facilitatly store the surface nodes of the first finite element model and the end contact points of the second finite element model, it can quickly identify the nearest model surface node that best fits each support point, thereby ensuring a faster merging process.

As an alternative embodiment, considering that the number of the nodes of the surface unit of the first finite element model is large, an algorithm for constructing a k-d tree is used.

In still another exemplary embodiment, determining whether the target finite element model satisfies the stress intensity condition, comprises: calculating the stresses of all the nodes in the target finite element model to obtain a target stress distribution, and calculating displacement of all the nodes in the target finite element model according to the data file to obtain a target displacement distribution, wherein the displacement deformation comprises a displacement amount of a node of the printing model relative to a corresponding node of the target finite element model, and a displacement amount of a node of the initial support model relative to a corresponding node in the target finite element model; and determining whether the target finite element model satisfies the stress intensity condition according to the target stress distribution and the target displacement distribution; and in cases where a stress of a node in the target finite element model is less than or equal to a yield stress of a material, determining that the node in the target finite element model satisfies the stress intensity condition. In the present embodiment, the stress and displacement deformations of all the nodes in the target finite element model are calculated to obtain a target stress distribution and a target displacement distribution; then, according to the target stress distribution and the target displacement distribution, it is determined whether the target finite element model satisfies a stress intensity condition; and when the stress of the node is less than or equal to the yield stress of the material, it is determined that the node satisfies the stress intensity condition, and it can be relatively accurately determined whether the node satisfies the stress intensity condition, and the specific positions of nodes not complying with the stress intensity condition can also be determined, so as to prepare for subsequent adjustment of the initial support model in the target finite element model according to the result.

As an alternative embodiment, in the target finite element model, if a preset proportion or more of the nodes satisfy the stress intensity condition, it is determined that the target finite element model satisfies the stress intensity condition. The preset proportion may be 80%, may also be 85%, may also be 90%, may also be 95%, may also be 98%, and may also be another proportion. In an actual application process, a person skilled in the art may set the preset proportion according to an empirical value, and may also obtain the preset proportion through multiple experiments, which is not specifically limited in the present disclosure.

As an alternative embodiment, the stress intensity condition may be a Von Mises Yield criterion, and may also be other types of stress intensity conditions. A person skilled in the art may flexibly select an appropriate stress intensity condition according to actual needs, which is not specifically limited in the present disclosure.

The calculating formula of the Von Mises Yield criterion is:

$$\sqrt{\frac{1}{2} [ {( {σ}_{1} - {σ}_{2} )}^{2} + {( {σ}_{2} - {σ}_{3} )}^{2} + {( {σ}_{3} - {σ}_{1} )}^{2} ]} \leq {σ}_{s} ,$$

Mises stress of the node, the right side is the yield stress of the material, and σ₁, σ₂ and σ₃ are the principal stresses of the node various directions.

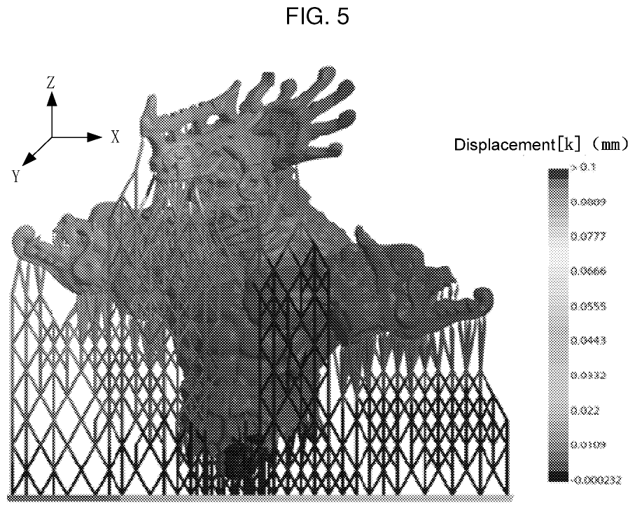

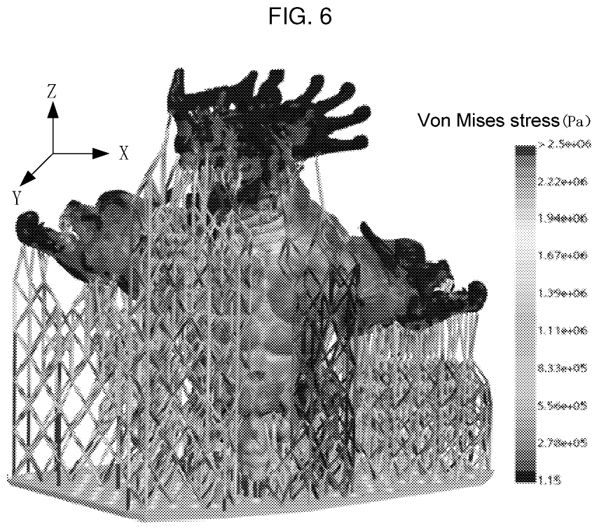

FIG. 5 is a diagram of a target displacement distribution result of a mechanical simulation of a printing model and an initial support model according to the present disclosure, and as show in FIG. 5, different grayscale values represent different displacement variables. FIG. 6 is a graph of a target stress distribution result of a mechanical simulation of a printing model and an initial support model according to the present disclosure, different grayscale values represent Von Mises stresses of different magnitudes.

As an alternative embodiment, intensity calibration may be performed on the target finite element model to determine a possible risk area in the printing model and the support model. For example, by adopting a certain design of a safety margin, a part where a ratio of stress to tensile strength of a resin material reaches 90% may be detected. By adjusting a max limit of the displacement and stress display to be a risk threshold, it is convenient to acquire the risk area of the printing model and the support model.

According to some other exemplary embodiments of the present disclosure, generating, according to the data file and the material property parameters, a finite element model of the printing model to obtain a first finite element model, comprises: performing meshing on the printing model according to the data file to obtain mesh model data; and constructing the finite element model of the printing model using polyhedron units according to the mesh model data and the material property parameters, to obtain the first finite element model. In the present embodiment, meshing is performed on the printing model to obtain mesh model data, and then according to the mesh model data and material property parameters, a finite element model of the printing model is constructed by using polyhedron units, so as to obtain the first finite element model, so that the original complex printing model can be divided into relatively simple and clear finite element models, to prepare for the subsequent, more convenient merging of the printed model and the initial support model.

As an alternative embodiment, the printing model is divided into meshes. In consideration of geometrical complexity of the printing model, a tetrahedral non-structural mesh is generally adopted, which has strong adaptability and high degree of automation. Since finite element analysis has a high requirement on the quality of a model mesh, it is necessary to firstly perform reconstruction of a surface mesh and then divide a volume mesh, so as to finally obtain a superior volume mesh model. The finite element model of the printing model is constructed using tetrahedral units. In practice, it is merely necessary to compute the stiffness of the printed model's elements.

Certainly, in addition to dividing the printing model by using a tetrahedral non-structured mesh, a hexagonal structured mesh may also be used. The present disclosure does not limit a specific meshing algorithm, as long as the condition for constructing a finite element model can be met.

In some other optional solutions of the present disclosure, adjusting the initial support model in the target finite element model comprises: adding and deleting connecting rods in the initial support model in the target finite element model according to nodes not satisfying the stress intensity condition in the target finite element model. In the present embodiment, connecting rods in the initial support model in the target finite element model are added and deleted according to nodes not satisfying the stress intensity condition in the target finite element model, so that in the finally obtained target support model, it can avoid the occurrence of insufficient support rods while also avoiding excessive redundant support rods, thereby further ensuring that the target support model is relatively reasonable.

As an alternative embodiment, if there is a risk node on the surface of the printing model, i.e., the lack of support on the surface of the printing model results in a high stress, then it is necessary to add an individual support connecting rod manually or by using an automatic algorithm; if there is a risk node in the initial support model, i.e. the stress of the initial support model reaches the max limit, then an individual support connecting rod needs to be added around the risk node manually or by using an automatic algorithm; if some support nodes experience very little force, or even no force at all, the corresponding connecting rods may be ignored. This operation may be automatically performed by the program, which marks the invalid rods. It can be implemented by multiplying the stiffness matrix of the corresponding beam element by a very small number, and ultimately modifying the parametric file of the support model, which is originally input.

The addition and deletion of the initial support model may be controlled independently. If it is desired to optimize the material cost of the initial support model, the addition and deletion of the initial support model may be considered. After manually or automatically adding rods and automatically removing redundant connecting rods by the program, an updated initial support model is obtained, and then it proceeds to step S203, merely the finite element model is updated for the local support data changed therein, and finally a new simulation result is obtained, until there are no risky nodes left.

In order to enable persons skilled in the art to understand the technical solutions of the present disclosure more clearly, the implementation process of the method for manufacturing the target object in the present disclosure is described in details as follows with reference to specific embodiments.

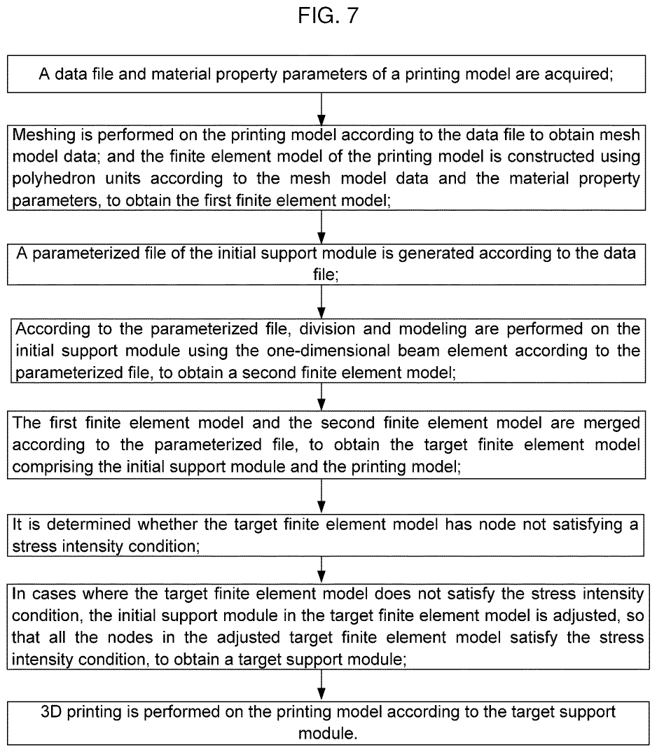

The present embodiment relates to a specific method for manufacturing a target object. As shown in FIG. 7, the method comprises the following steps:
step S1: a data file and material property parameters of a printing model are acquired, wherein the printing model is a three-dimensional model to be printed;
step S2: meshing is performed on the printing model according to the data file to obtain mesh model data; and the finite element model of the printing model is constructed using polyhedron units according to the mesh model data and the material property parameters, to obtain the first finite element model;
step S3: a parameterized file of the initial support model is generated according to the data file, the initial support model being a structure supporting the printing model in a printing process, wherein the parameterized file comprises files representing the geometric characteristics of the initial support model and a connection relationship between the initial support model and the printing model;
step S4: according to the parameterized file, division and modeling are performed on the initial support model using the one-dimensional beam element according to the parameterized file, to obtain a second finite element model;
step S5: the first finite element model and the second finite element model are merged according to the parameterized file, to obtain the target finite element model including the initial support model and the printing model;
step S6: it is determined whether the target finite element model satisfies a stress intensity condition;
step S7: in cases where the target finite element model does not satisfy the stress intensity condition, adjusting the initial support model in the target finite element model, so that all the nodes in the adjusted target finite element model satisfy the stress intensity condition, to obtain a target support model; and
step S8: 3D printing is performed on the printing model according to the target support model.

It should be noted that the steps illustrated in the flowchart of the drawings can be executed in a computer system such as a set of computer-executable instructions, and although a logical order is shown in the flowchart, in some cases, the steps shown or described can be executed in a different order from that described herein.

An embodiment of the present disclosure further provides an apparatus for manufacturing a target object. It should be noted that, the apparatus for manufacturing a target object in the embodiment of the present disclosure may be configured to execute the method for manufacturing the target object according to the embodiment of the present disclosure. The apparatus is used for implementing the described embodiments and preferred embodiments, and what has been described will not be repeated again. As used below, the term “module” may implement a combination of software and/or hardware of predetermined functions. Although the apparatus described in the following embodiments is preferably implemented in software, implementation in hardware or a combination of software and hardware is also possible and conceived.

Hereinafter, the apparatus for manufacturing a target object according to an embodiment of the present disclosure is introduced.

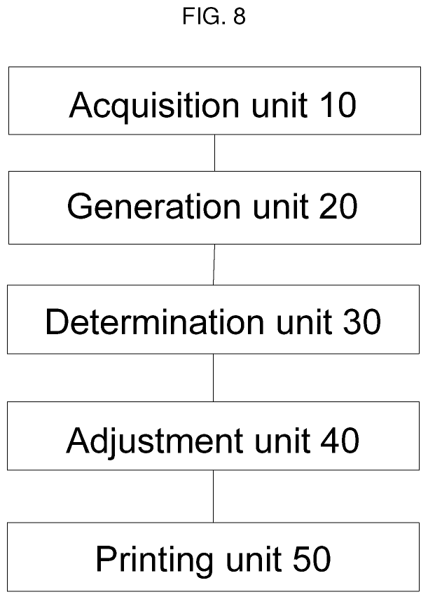

FIG. 8 is a schematic diagram of an apparatus for manufacturing a target object according to an embodiment of the present disclosure. As shown in FIG. 8, the apparatus comprises:
an acquisition unit 10, configured to acquire a data file and material property parameters of a printing model, the printing model being a three-dimensional model to be printed.

As an alternative embodiment, the data file may be in a StereoLithography (STL) data format, and may also be in another data format, which depends on a calculation program of the simulation analysis, and is not specifically limited in the present disclosure.

As an alternative embodiment, for DLP 3D printing technology, although the support structures and the photopolymer resin of the model are not 100% fully photocured during the actual molding process, considering the complexity of the resin material, it can be approximated that the material properties of the fully photocured photopolymer resin are used. Later, detailed adjustments may be made through strict testing and comparison. Considering the current application scenario, a linear static simulation analysis method may be used for approximate analysis. In linear static simulation analysis, the elastic modulus and Poisson's ratio are the physical property parameters that determine the material stress and strain in the stress condition. Taking gravity into account, the density parameters need to be provided. Thus, the material property parameters include, but are not limited to, the elastic modulus, Poisson's ratio and density of the resin.

The apparatus comprises a generation unit 20, configured to generate an initial support model and a target finite element model comprising the initial support model according to the data file and the material property parameters.

As an alternative embodiment, the initial support model may be generated from the geometric characteristics of the model printability and the extensive 3D printing practical experience.

The determination unit 30, configured to determine whether the target finite element model satisfies a stress intensity condition;
an adjustment unit 40, configured to adjust, in cases where the target finite element model does not satisfy the stress intensity condition, the initial support model in the target finite element model, so that the adjusted target finite element model satisfies the stress intensity condition, to obtain a target support model; and
a printing unit 50, configured to perform 3D printing on the printing model according to the target support model.

By means of the described embodiments, a data file and material property parameters of a three-dimensional model to be printed are acquired by the acquisition unit; an initial support model and a target finite element model comprising the initial support model are generated by the generation unit according to the data file and the material property parameters; whether the target finite element model satisfies a stress intensity condition is determined by the determination unit; in cases where the target finite element model does not satisfy the stress intensity condition, the initial support model in the target finite element model is adjusted by the adjustment unit, so that the adjusted target finite element model satisfies the stress intensity condition, to obtain a target support model; and 3D printing is performed on the printing model according to the target support model by the printing unit. Compared with related art, where support models are often unreasonably designed due to the difficulty of efficient and accurate analysis, leading to various problems during the 3D printing process, the present disclosure generates an initial support model and a target finite element model comprising the initial support model on the basis of the data file and material property parameters of the printing model, then determines whether the target finite element model meets the stress intensity requirements, if not, adjusts the initial support model in the target finite element model, so as to ensures that obtained support model is good. In other words, the present disclosure can guide the design of the support model by the actual stress result of the model and the support, and determine whether the design of the support model is reasonable and whether the support model is strong enough to support the model, so as to ensure successful model printing, thereby avoiding problems such as model detachment caused by an unreasonable support structure during 3D printing, ensuring that the model remains properly fixed, and effectively improving model deformation due to insufficient support structure, and guaranteeing high accuracy in the final printed 3D model. In addition, by means of the technical solution of the present disclosure, while reasonably designing a support model, it can be determined whether there is a redundant support model, thereby reducing redundant support models in a model, thereby reducing the consumption of printing materials and saving costs.

In an optional solution, the generation unit comprises: a first generation sub-unit, configured to generate, according to the data file and the material property parameters, a finite element model of the printing model to obtain a first finite element model; a second generation sub-unit, configured to generate a parameterized file of the initial support model according to the data file, the initial support model being a structure supporting the printing model in a printing process; a third generation sub-unit, configured to generate the finite element model of the initial support model according to the parameterized file, to obtain a second finite element model; and a merging sub-unit, configured to merge the first finite element model and the second finite element model according to the parameterized file, to obtain the target finite element model comprising the initial support model and the printing model. In the present embodiment, by separately establishing the finite element model of the printing model and the finite element model of the initial support model, then merging the first finite element model and the second finite element model to obtain a target finite element model, it ensures that the obtained target finite element model is relatively adaptive, and prepares for subsequently determining whether the target finite element model satisfies a stress intensity condition, thereby further ensuring that a target support model obtained subsequently is relatively superior, and further ensuring high precision of a three-dimensional model that is finally printed is relatively high, and further reducing the consumption of the subsequent printing materials.

As an alternative embodiment, the parameterized file comprises files representing the geometric characteristics of the initial support model and a connection relationship between the initial support model and the printing model.

As an alternative embodiment, the parameterized file comprises data information such as a connection relationship of the initial support model, the positions of connection nodes inside the initial support model, the positions of connection nodes between the initial support model and the printing model, and the sectional shape and size of a support rod between any two connection points of the initial support model.

In other embodiments, the third generation sub-unit comprises: a first division module, configured to divide and model the initial support model according to the parameterized file, to obtain the second finite element model. In the present embodiment, the initial support model is divided and modeled, which ensures that the process of generating the second finite element model is relatively simple and efficient, and ensures that the process of subsequently merging the first finite element model and the second finite element model is relatively simple and convenient.

In practical application, considering that the initial support model has an elongated beam feature, a one-dimensional Euler-Bernoulli beam element may be used to perform rapid simplified modeling. Certainly, those skilled in the art may also use other unit division manners to perform division modeling, such as a one-dimensional bar unit, which is not specifically limited in the present disclosure. In practice, it is only necessary to complete the calculation of the element stiffness of the initial support model.

In other embodiments, the third generation sub-unit comprises: a first determination module, configured to determine, according to the parameterized file, position coordinates of connection nodes between the initial support model and the printing model, to obtain contact position coordinates; a second determination module, configured to determine a polyhedron unit closest to the connection node in the first finite element model according to the contact position coordinates, to obtain a target polyhedron unit; a coupling module, configured to determine force coupling and transferring of the target polyhedron unit and the second finite element model using a multipoint constraint equation in a finite element method, to obtain an initial finite element model; and a constraint module, configured to impose a boundary constraint and a load constraint to the initial finite element model to obtain the target finite element model. In the present embodiment, the position coordinates of the connection node between the initial support model and the printing model are determined; according to the position coordinates, a polyhedral unit, which is closest to the connection node in the first finite element model, is determined; force coupling and transferring of the target polyhedron unit and the one-dimensional beam element in the second finite element model is determined using a multipoint constraint equation; a boundary constraint and a load constraint are applied to obtain the target finite element model, which ensures a good matching between the first finite element unit and the second finite element unit during merging, i.e. it is ensured that the compatibility is relatively superior, which further ensures that the deformation of the printing model is more real and reasonable, and the target finite element model can be superior analyzed and adjusted subsequently.

As an alternative embodiment, the foregoing polyhedron unit may be a tetrahedron unit, a hexahedron unit, or another polyhedron unit, and is specifically determined according to a grid division manner performed on the printing model in the process of generating the first finite element model.

As an alternative embodiment, the multipoint constraint equation is a linear relationship equation established between the degrees of freedom of different grids or different units, so as to achieve mutual coupling and transfer of physical field information between the degrees of freedom of different models or different degrees of freedom of the same model. A multipoint constraint equation is a constraint relationship between two degrees of freedom. The degree of freedom is an unknown quantity included in unit nodes of a computing model in finite element analysis; each node in a polyhedron unit in the first finite element model contains three degrees of freedom; the degree of freedom of displacement (Uₓ U_{y} U_{z}) in three directions; and each node in the one-dimensional beam unit in the second finite element model contains six degrees of freedom, i.e. the degree of freedom of displacement in three directions (Uₓ U_{y} U_{z}), and the degree of freedom of rotation in three directions (Rotₓ Rot_{y} Rot_{z}).

As an alternative embodiment, the boundary constraint is a type of constraint for a specified degree of freedom of a specified node in a finite element simulation analysis model, for example, completely fixed, i.e. the displacements in three directions are zero (Uₓ=U_{y}=U_{z}=0), and the rotations in three directions are also zero (Rotₓ=Rot_{y}=Rot_{z}=0). The load constraint is a load condition that the model needs to bear in the finite element simulation analysis model, has a plurality of types, such as a concentrated force, a volume force and a distributed force, and generally has a load constraint such as gravity.

FIG. 4 is a schematic diagram of a photocuring process principle of DLP 3D printing in the present disclosure. It can be determined from FIG. 4 that, in the 3D printing process, the required devices include, but are not limited to, a printer cover 11, a forming platform 12, a Z-axis assembly 13, a material tray 14, protection glass 15 and a light shield 16.

As an alternative embodiment, in the 3D printing process, the bottom of the support structure is completely fixed to the forming platform. As the lifting mechanism of the DLP printer moves up and down at a slow speed, the dynamic effect may be ignored, i.e. a fixing constraint is imposed on the bottom of the initial support model in the initial finite element model. There are mainly two load constraints, one is the model weight itself, and the other is the peeling force between each layer of the liquid resin after being photocured and the material tray in the forming process of the DLP 3D process; since the size thereof is mainly due to the size of the slicing area, the calculation relationship thereof is obtained through a lot of internal tests and summaries.

According to some exemplary embodiments of the present disclosure, the second determination module comprises: a determining sub-module, configured to determine a polyhedron unit closest to the connection node in the first finite element model according to the contact position coordinates and by means of an algorithm for constructing a k-d tree, to obtain a target polyhedron unit. In the present embodiment, an algorithm for constructing a k-d tree is used to determine a polyhedron unit closest to a connection node in a first finite element model, since the k-d tree may store the surface nodes of the first finite element model and the end contact points of the second finite element model, therefore the nearest model surface node that best fits each support point may be quickly identified, thereby ensuring a faster merging process.

As an alternative embodiment, considering that the number of the nodes of the surface unit of the first finite element model is large, an algorithm for constructing a k-d tree is used.

In another exemplary embodiment, the determination unit comprises: a calculating sub-unit, configured to calculate the stresses of all the nodes in the target finite element model to obtain a target stress distribution, and calculate displacement of all the nodes in the target finite element model according to the data file to obtain a target displacement distribution, wherein the displacement deformation comprises a displacement amount of a node of the printing model relative to a corresponding node of the target finite element model, and a displacement amount of a node of the initial support model relative to a corresponding node in the target finite element model; and a determination sub-unit, configured to determine whether the target finite element model satisfies the stress intensity condition according to the target stress distribution and the target displacement distribution; and in cases where a stress of a node in the target finite element model is less than or equal to a yield stress of a material, determine that the node in the target finite element model satisfies the stress intensity condition. In the present embodiment, the stress and displacement deformations of all the nodes in the finite element model are calculated to obtain a target stress distribution and a target displacement distribution; then, according to the target stress distribution and the target displacement distribution, it is determined whether the target finite element model satisfies a stress intensity condition; and when the stress of the node is less than or equal to the yield stress of the material, it is determined that the node satisfies the stress intensity condition, and it can be relatively accurately determined whether the node complies with the stress intensity condition, and the specific positions of nodes not complying with the stress intensity condition can also be determined, so as to prepare for subsequent adjustment of the initial support model in the target finite element model according to the result.

As an alternative embodiment, in the target finite element model, if a preset proportion or more of the nodes satisfy the stress intensity condition, it is determined that the target finite element model satisfies the stress intensity condition. The preset proportion may be 80%, may also be 85%, may also be 90%, may also be 95%, may also be 98%, and may also be another proportion. In an actual application process, a person skilled in the art may set the preset proportion according to an empirical value, and may also obtain the preset proportion through multiple experiments, which is not specifically limited in the present disclosure.

As an alternative embodiment, the stress intensity condition may be a Von Mises Yield criterion, and may also be other types of stress intensity conditions. A person skilled in the art may flexibly select an appropriate stress intensity condition according to actual needs, which is not specifically limited in the present disclosure.

The calculating formula of the Von Mises Yield criterion is:

$$\sqrt{\frac{1}{2} [ {( {σ}_{1} - {σ}_{2} )}^{2} + {( {σ}_{2} - {σ}_{3} )}^{2} + {( {σ}_{3} - {σ}_{1} )}^{2} ]} \leq {σ}_{s} ,$$

wherein in the formula, the left side is the Von Mises stress of the node, the right side is the yield stress of the material, and σ₁, σ₂ and σ₃ are the principal stresses of the node various directions.

FIG. 5 is a diagram of a target displacement distribution result of a mechanical simulation of a printing model and an initial support model according to the present disclosure, and in FIG. 5, different grey scale values represent different displacement variables; FIG. 6 is a graph of a target stress distribution result of a mechanical simulation of a printing model and an initial support model according to the present disclosure, different grayscale values represent Von Mises stresses of different sizes.

As an alternative embodiment, intensity calibration may be performed on the target finite element model to determine a possible risk area in the printing model and the support model. For example, by adopting a certain design of a safety margin, a part where a ratio of stress to tensile strength of a resin material reaches 90% can be detected. By adjusting a max limit of the displacement and stress display to be a risk threshold, it is convenient to acquire the risk area of the printing model and the support model.

According to some other exemplary embodiments of the present disclosure, the first generation sub-unit comprises: a second division module, configured to perform meshing on the printing model according to the data file to obtain mesh model data; and a construction module, configured to construct the finite element model of the printing model using polyhedron units according to the mesh model data and the material property parameters, to obtain the first finite element model. In the present embodiment, meshing is performed on the printing model to obtain mesh model data, and then according to the mesh model data and material property parameters, a finite element model of the printing model is constructed by using polyhedron units, so as to obtain the first finite element model, so that the original complex printing model can be divided into relatively simple and clear finite element models, to prepare for the subsequent, more convenient merging of the printed model and the initial support model.

As an alternative embodiment, the printing model is divided into meshes. In consideration of geometrical complexity of the printing model, a tetrahedral non-structural mesh is generally adopted, which has strong adaptability and high degree of automation. Since finite element analysis has a high requirement on the quality of a model mesh, it is necessary to firstly perform reconstruction of a surface mesh and then divide a volume mesh, so as to finally obtain a good volume mesh model. The finite element model of the printing model is constructed using tetrahedral units. In practice, it is merely necessary to compute the stiffness of the printed model's elements.

Certainly, in addition to dividing the printing model by using a tetrahedral non-structured mesh, a hexagonal structured mesh may also be used. The present disclosure does not limit a specific meshing algorithm, as long as the condition for constructing a finite element model can be met.

In still some optional solutions of the present disclosure, the adjustment unit comprises: an addition and deletion sub-unit, configured to add and delete, in cases where the target finite element model does not satisfy the stress intensity condition, connecting rods in the initial support model in the target finite element model according to nodes not satisfying the stress intensity condition in the target finite element model. In the present embodiment, connecting rods in the initial support model in the target finite element model are added and deleted according to nodes not satisfying the stress intensity condition in the target finite element model, so that in the finally obtained target support model, it can avoid the occurrence of insufficient support rods while also avoiding excessive redundant support rods, thereby further ensuring that the target support model is relatively reasonable.

As an alternative embodiment, if there is a risk node on the surface of the printing model, i.e., the lack of support on the surface of the printing model results in a high stress, then it is necessary to add an individual support connecting rod manually or by using an automatic algorithm; if there is a risk node in the initial support model, i.e. the stress of the initial support model reaches the max limit, then an individual support connecting rod needs to be added around the risk node manually or by using an automatic algorithm; if some support nodes experience very little force, or even no force at all, the corresponding connecting rods can be ignored. This operation may be automatically performed by the program, which marks the invalid rods. It can be implemented by multiplying the stiffness matrix of the corresponding beam element by a very small number, and ultimately modifying the parametric file of the original input support model.

The addition and deletion of the initial support model can be controlled independently, and if it is desired to optimize the material cost of the initial support model, the addition and deletion of the initial support model may be considered. After manually or automatically adding rods and automatically removing redundant connecting rods by the program, an updated initial support model is obtained, and then by means of the second generation unit, merely the finite element model is updated for the local support data changed therein, and finally a new simulation result is obtained, until there are no risky nodes left.

The apparatus for manufacturing the target object comprises a processor and a memory, wherein the acquisition unit, the first generation unit, the second generation unit, the third generation unit, the merging unit, the determination unit, the adjustment unit and the printing unit are all stored in the memory as program units, and the processor executes the described program units stored in the memory to implement corresponding functions. The modules can be located in the same processor; or all the modules above are located in different processors in any arbitrary combination manner.

Embodiments of the present disclosure provide a computer readable storage medium, wherein the computer-readable storage medium comprises a stored program; and when the program runs, the computer-readable storage medium is controlled to execute any method for manufacturing a target object.

As an alternative embodiment, the method for manufacturing the target object comprises:
step S201: a data file and material property parameters of a printing model are acquired, wherein the printing model is a three-dimensional model to be printed.

As an alternative embodiment, the data file may be in a StereoLithography (STL) data format, and may also be in another data format, which depends on a calculation program of the simulation analysis, and is not specifically limited in the present disclosure.

As an alternative embodiment, for DLP 3D printing technology, although the support structures and the photopolymer resin of the model are not 100% fully photocured during the actual molding process, considering the complexity of the resin material, it may be approximated that the material properties of the fully photocured photopolymer resin are used. Later, detailed adjustments may be made through strict testing and comparison. Considering the current application scenario, a linear static simulation analysis method may be used for approximate analysis. In linear static simulation analysis, the elastic modulus and Poisson's ratio are the physical property parameters that determine the material stress and strain in the stress condition. Taking gravity into account, the density parameters need to be provided. Thus, the material property parameters include, but are not limited to, the elastic modulus, Poisson's ratio and density of the resin.

Step S202: an initial support model and a target finite element model comprising the initial support model are generated according to the data file and the material property parameters.

As an alternative embodiment, the initial support model may be generated according to the geometric characteristics of the model printability and the extensive 3D printing practical experience.

Step S203: it is determined whether the target finite element model satisfies a stress intensity condition.

Step S204: in cases where the target finite element model does not satisfy the stress intensity condition, the initial support model in the target finite element model is adjusted, so that the adjusted target finite element model satisfies the stress intensity condition, to obtain a target support model.

Step S205: 3D printing is performed on the printing model according to the target support model.

In some embodiments, the generating an initial support model and a target finite element model comprising the initial support model according to the data file and the material property parameters comprises: generating, according to the data file and the material property parameters, a finite element model of the printing model to obtain a first finite element model; generating a parameterized file of the initial support model according to the data file, the initial support model being a structure supporting the printing model in a printing process; generating the finite element model of the initial support model according to the parameterized file, to obtain a second finite element model; and merging the first finite element model and the second finite element model according to the parameterized file, to obtain the target finite element model comprising the initial support model and the printing model.

In some embodiments, generating the finite element model of the initial support model according to the parameterized file, to obtain a second finite element model comprises: performing division and modeling on the initial support model according to the parameterized file, to obtain the second finite element model.

In some embodiments, merging the first finite element model and the second finite element model according to the parameterized file, to obtain the target finite element model comprising the initial support model and the printing model, comprises: determining position coordinates of a connection node between the initial support model and the printing model according to the parameterized file, to obtain contact position coordinates; determining a polyhedron unit closest to the connection node in the first finite element model according to the contact position coordinates, to obtain a target polyhedron unit; force coupling and transferring of the target polyhedron unit and the second finite element model is determined using a multipoint constraint equation in a finite element method, to obtain an initial finite element model; and applying a boundary constraint and a load constraint to the initial finite element model to obtain the target finite element model.

In some embodiments, determining the polyhedron unit closest to the connection node in the first finite element model according to the contact position coordinates to obtain the target polyhedron unit, comprises: determining a polyhedron unit closest to the connection node in the first finite element model according to the contact position coordinates and by means of an algorithm for constructing a k-d tree, to obtain a target polyhedron unit.

In some embodiments, determining whether the target finite element model satisfies the stress intensity condition, comprises: calculating the stresses of all the nodes in the target finite element model to obtain a target stress distribution, and calculating displacement of all the nodes in the target finite element model according to the data file to obtain a target displacement distribution, wherein the displacement comprises a displacement amount of a node of the printing model relative to a corresponding node of the target finite element model, and a displacement amount of a node of the initial support model relative to a corresponding node in the target finite element model; and determining whether the target finite element model satisfies the stress intensity condition according to the target stress distribution and the target displacement distribution; and in cases where a stress of a node in the target finite element model is less than or equal to a yield stress of a material, determining that the node in the target finite element model satisfies the stress intensity condition.

In some embodiments, generating, according to the data file and the material property parameters, a finite element model of the printing model to obtain a first finite element model, comprises: performing meshing on the printing model according to the data file to obtain mesh model data; and constructing the finite element model of the printing model using polyhedron units according to the mesh model data and the material property parameters, to obtain the first finite element model.

In some embodiments, adjusting the initial support model in the target finite element model comprises: adding and deleting connecting rods in the initial support model in the target finite element model according to nodes not satisfying the stress intensity condition in the target finite element model.

From the above description, it can be determined that the above embodiments of the present disclosure achieve the following technical effects:

1). In the method for manufacturing the target object of the present disclosure, a data file and material property parameters of a three-dimensional model to be printed are first acquired; then an initial support model and a target finite element model comprising the initial support model are generated according to the data file and the material property parameters; then it is determined whether the target finite element model satisfies a stress intensity condition; in cases where the target finite element model does not satisfy the stress intensity condition, the initial support model in the target finite element model is adjusted, so that the adjusted target finite element model satisfies the stress intensity condition, to obtain a target support model; and finally 3D printing is performed on the printing model according to the target support model. Compared with the existing art, where support models are often unreasonably designed due to the difficulty of efficient and accurate analysis, leading to various problems during the 3D printing process, the present disclosure generates an initial support model and a target finite element model comprising the initial support model on the basis of the data file and material property parameters of the printing model, then determines whether the target finite element model meets the stress intensity requirements, if not, adjusts the initial support model in the target finite element model, so as to ensures that obtained support model is good. In other words, the present disclosure can guide the design of the support model by the actual stress result of the model and the support, and determine whether the design of the support model is reasonable and whether the support model is strong enough to support the model, so as to ensure successful model printing, thereby avoiding problems such as model detachment caused by an unreasonable support model during 3D printing, ensuring that the model remains properly fixed, and effectively improving model deformation due to insufficient support, and guaranteeing high accuracy in the final printed 3D model. In addition, by means of the technical solution of the present disclosure, while reasonably designing a support model, it can be determined whether there is a redundant support model, thereby reducing redundant support models in a model, thereby reducing the consumption of printing materials and saving costs.

2) In the apparatus for manufacturing a target object of the present disclosure, a data file and material property parameters of a three-dimensional model to be printed are acquired by means of the acquisition unit; an initial support model and a target finite element model comprising the initial support model are generated by the generation unit according to the data file and the material property parameters; whether the target finite element model satisfies a stress intensity condition is determined by the determination unit; in cases where the target finite element model does not satisfy the stress intensity condition, the initial support model in the target finite element model is adjusted by the adjustment unit, so that the adjusted target finite element model satisfies the stress intensity condition, to obtain a target support model; and 3D printing is performed on the printing model according to the target support model by means of the printing unit. Compared with existing art, where support models are often unreasonably designed due to the difficulty of efficient and accurate analysis, leading to various problems during the 3D printing process, the present disclosure generates an initial support model and a target finite element model comprising the initial support model on the basis of the data file and material property parameters of the printing model, then determines whether the target finite element model meets the stress intensity requirements, if not, adjusts the initial support model in the target finite element model, so as to ensures that obtained support model is good. In other words, the present disclosure can guide the design of the support model by the actual stress result of the model and the support, and determine whether the design of the support model is reasonable and whether the support model is strong enough to support the model, so as to ensure successful model printing, thereby avoiding problems such as model detachment caused by an unreasonable support structure during 3D printing, ensuring that the model remains properly fixed, and effectively improving model deformation due to insufficient support structure, and guaranteeing high accuracy in the final printed 3D model. In addition, by means of the technical solution of the present disclosure, while reasonably designing a support model, it can be determined whether there is a redundant support model, thereby reducing redundant support models in a model, thereby reducing the consumption of printing materials and saving costs.

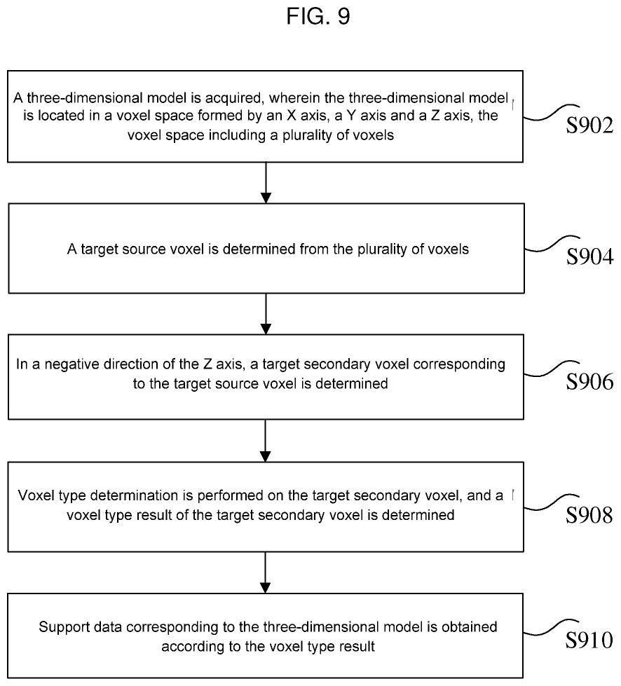

In order to solve the technical problem that the support condition of a printed three-dimensional model is unstable, the embodiments of the present disclosure provide a method for determining a parameterized file of an initial support model. The parameterized file may include support data corresponding to the three-dimensional model. FIG. 9 is a flowchart of a method for determining support data of a three-dimensional model according to an embodiment of the present disclosure. As shown in FIG. 9, the method comprises the following steps:
step S902: a three-dimensional model is acquired, wherein the three-dimensional model is located in a voxel space formed by an X axis, a Y axis and a Z axis, the voxel space comprising a plurality of voxels;
in step S902 provided in the present disclosure, the three-dimensional model is acquired; the three-dimensional model may be a model placed in a three-dimensional rectangular coordinate system formed by an X axis, a Y axis and a Z axis, and a space in which the coordinate system is located is also a space formed by voxels. Voxel support data corresponding to the three-dimensional model is determined by acquiring the three-dimensional model in a voxel space, thereby improving the stability of a printed three-dimensional model.

Step S904: a target source voxel is determined from the plurality of voxels;
in step S904 provided in the present disclosure, a target source voxel relating to the target voxel vertex is determined from the plurality of voxels included in the voxel space. That is, the target source voxel relating to the target voxel vertex is determined. It can be determined that a target voxel vertex may have eight neighboring voxels. The target source voxel may be determined from these eight voxels.

Furthermore, since the support model is built downward from the support point, the target source voxel may be determined from the four voxels of which the Z-coordinates are lower than those of others. The specific settings can be designed adaptively according to practical applications and scenarios.

Step S906: in a negative direction of the Z axis, a target secondary voxel corresponding to the target source voxel is determined;
in step S906 provided in the present disclosure, the target secondary voxel corresponding to the target source voxel is determined in the negative direction of the Z axis, i.e. after the target source voxel connected to the support point is determined, the target secondary voxel connected to the target source voxel is also determined, and by determining the voxels step by step, the purpose of determining the voxels from the support point step by step and connecting same to the base to form the support model can be achieved.

Step S908: voxel type determination is performed on the target secondary voxel, and a voxel type result of the target secondary voxel is determined;
in step S908 provided in the present disclosure, the voxel type of the target secondary voxel is determined to determine the next-level voxel according to the type result, so as to perform targeted processing for different situations.

Step S910: support data corresponding to the three-dimensional model is obtained according to the voxel type result.

In step S910 provided in the present disclosure, it can be determined that the determination of the support data is related to the type of the current target secondary voxel. The method facilitates superior voxel selection for forming the support model. In this way, support data corresponding to the three-dimensional model is obtained.

It should be noted that, the finally determined support data may include a support point, a target source voxel corresponding to the support point, a target secondary voxel, and a plurality of next-level voxels, until a corresponding voxel with a Z coordinate being a baseplate coordinate is determined. By means of the support data, a support model can be accurately constructed to support a printed three-dimensional model.

By means of steps S902-S910, a three-dimensional model is acquired, wherein the three-dimensional model is located in a voxel space formed by an X axis, a Y axis and a Z axis, the voxel space comprising a plurality of voxels; a target source voxel is determined from the plurality of voxels; in a negative direction of the Z axis, a target secondary voxel corresponding to the target source voxel is determined; voxel type determination is performed on the target secondary voxel, and a voxel type result of the target secondary voxel is determined; and support data corresponding to the three-dimensional model is obtained according to the voxel type result. By means of the described steps, a voxel for supporting is determined level by level, so as to obtain support data; a support is added to a three-dimensional model according to the support data; after the addition of a support is completed, printing data of the three-dimensional model is generated; and the three-dimensional model is printed according to the printing data of the three-dimensional model. By means of the method, when a three-dimensional model is printed according to printing data, the support condition of the printed three-dimensional model is more stable, thereby solving the technical problem in the related art that when a three-dimensional model is printed according to three-dimensional printing data comprising support data, the support condition of the printed three-dimensional model is unstable.

In addition, by means of the method, the design of the 3D model support can be optimized, such as reducing redundant supports to decrease material usage, or adding supports to areas with weak stress on the 3D model to reduce the risk of print detachment and improve printing efficiency. It also allows for avoiding the main body of the 3D model, preventing supports from being added to the surface of the model, which could affect the surface quality of model printing.

As an optional embodiment, determining a target source voxel from the plurality of voxels comprises: acquiring a support point corresponding to the three-dimensional model; determining a target voxel vertex corresponding to the support point; and determining, from the plurality of voxels, a target source voxel relating to the target voxel vertex.

In the present embodiment, a support point corresponding to the three-dimensional model is acquired, wherein the support point may be directly acquired or obtained by analyzing the three-dimensional model. By adding a support at a support point, the three-dimensional model can be supported during printing, thereby smoothly performing three-dimensional printing.

In the present embodiment, a target voxel vertex corresponding to the support point is also determined. In order to maximize the stability of the support, the algorithm needs to calculate the most appropriate voxel vertexes starting from the support point, so as to connect the voxel vertexes to form the support. That is, since the voxel space is formed by a plurality of voxels, a voxel may be understood as a cube that has a plurality of vertices.

In this case, in the embodiment provided in the present disclosure, the data of the support model supporting the three-dimensional model needs to be determined on the three-dimensional model. That is, it may be understood that the support model starting from the support point and ending at the lowest Z coordinate (which may also be understood as a coordinate corresponding to the baseplate on which the three-dimensional model is placed) of the three-dimensional model is determined to support the three-dimensional model.

Hence, when determining the support model, the connection relationship between the support point and other voxels may be used to determine a support model that starts from the support point, passes through individual voxels, and gradually connects to the base.

Therefore, the first voxel connected to the support point is first to be determined. When the first voxel connected to the support point is determined, a target voxel vertex corresponding to the support point needs to be determined first, that is, a point to be connected to the point is determined, so as to subsequently determine the first voxel connected to the support point.

It should be noted that, in this case, the determined support point may not lie exactly on the vertex of a voxel, and may also lie exactly on the vertex of a voxel. Therefore the target voxel vertex corresponding to the support point needs to be determined, as to determine the first point to which the support point is to be connected, so as to perform subsequent steps.

It should also be noted that, when there are a plurality of support points, target voxel vertexes corresponding to the support points need to be determined respectively, and these target voxel vertexes may be the same or different, and may be selected according to actual situations.

In the present embodiment, a target source voxel relating to the target voxel vertex is also determined from the plurality of voxels included in the voxel space. That is, the target source voxel relating to the target voxel vertex is determined. It can be determined that a target voxel vertex may have eight neighboring voxels. The target source voxel may be determined from these eight voxels.

Furthermore, since the support model is built downward from the support point, the target source voxel can be determined from the four voxels of which the Z-coordinates are lower than those of others. The specific settings may be designed adaptively according to practical applications and scenarios.

As an optional embodiment, obtaining support data corresponding to the three-dimensional model according to the voxel type result, comprises: determining a next-level voxel according to whether the voxel type result is a blocking voxel type, until a corresponding voxel with a Z coordinate being a baseplate coordinate is determined, so as to obtain support data corresponding to the three-dimensional model.

In the present embodiment, it is determined whether the voxel type result of the target secondary voxel is a blocking voxel type, and the next-level voxel is determined according to the type result. Hence, the selection of the next-level voxel is related to the type of the current target secondary voxel. The method facilitates superior voxel selection for forming the support model. In this way, until a corresponding voxel with a Z coordinate being a baseplate coordinate is determined, support data corresponding to the three-dimensional model is obtained.

It should be noted that, in this way, in the process of until determining a corresponding voxel with a Z coordinate being a baseplate coordinate, the type of the currently determined voxel is also used to determine the next-level voxel, and this process continues until a voxel that is able to be connected to the base is determined, achieving the purpose of determining the voxels from the support point step by step and connecting same to the base to form the support model.

It should be noted that, the finally determined support data may comprise a support point, a target source voxel corresponding to the support point, a target secondary voxel, or a plurality of next-level voxels, until a corresponding voxel with a Z coordinate being a baseplate coordinate is determined. By means of the support data, a support model can be accurately constructed to support a printed three-dimensional model.

As an optional embodiment, determining a next-level voxel according to whether the voxel type result is a blocking voxel type, until a corresponding voxel with a Z coordinate being a baseplate coordinate is determined, so as to obtain support data corresponding to the three-dimensional model, comprises: in cases where the voxel type of the target secondary voxel is the blocking voxel type, determining a target adjacent voxel corresponding to the target secondary voxel, wherein a Z coordinate of the target adjacent voxel is the same as a Z coordinate of the target secondary voxel; and determining the next-level voxel by taking the target adjacent voxel as a new source voxel, until a corresponding voxel with a Z coordinate being a baseplate coordinate is determined, so as to obtain the support data, wherein the baseplate coordinate is a minimum coordinate of the three-dimensional model in the direction of the Z axis.

The present embodiment explains the step of determining the support data in cases where the type result is that the voxel type of the target secondary voxel is the blocking voxel type. In this case, it is explained that the process of determining the next voxel downwards is blocked, i.e., some model parts of the three dimensional model block the target secondary voxel from finding the voxel downwards.

In this case, the three-dimensional model needs to be bypassed; the bypassing manner may be determining a target adjacent voxel corresponding to the target secondary voxel, i e. determining, beside the target secondary voxel, a next-level voxel with the same Z coordinate, and extending sideways rather than downwards, for the purpose of bypassing the model parts of the three-dimensional model. After the next-level voxel is determined, the foregoing steps continue to be repeated by taking the next-level voxel as a starting point, i.e. continuing to search downwards. That is, the next-level voxel is determined by using the target adjacent voxel as a new source voxel. If, after extending sideways, the downward search still encounters a blocking voxel, then, according to the content described in the embodiment, the search will continue in the vicinity for a voxel with the same Z-coordinate, and this process will be repeated until a corresponding voxel with a Z coordinate being a baseplate coordinate is determined, so as to obtain final support data.

By means of the method, the blocking of the model parts of a three-dimensional model is bypassed, so that the printed three-dimensional model can be disassembled more conveniently; in addition, a blocking part of a three-dimensional model is bypassed, so that the support model can fall onto the base, and the support model supporting the three-dimensional model is more capable of providing support.

As an optional embodiment, the determining a target adjacent voxel corresponding to the target secondary voxel comprises: determining at least one candidate adjacent voxel corresponding to the target secondary voxel, wherein a Z coordinate of the at least one candidate adjacent voxel is the same as a Z coordinate of the target secondary voxel, and the distance between the at least one candidate adjacent voxel and the target secondary voxel is less than a first predetermined threshold; and determining the target adjacent voxel from the at least one candidate adjacent voxel.

In the present embodiment, the step of determining a target adjacent voxel corresponding to the target secondary voxel is illustrated. At least one candidate adjacent voxel corresponding to the target secondary voxel is determined first, wherein the distance between the vertex of the at least one candidate voxel and the support point is less than a first pre-determined threshold, which ensures that the distance between the distance of the at least one candidate adjacent voxel and the target secondary voxel is relatively close, and avoids the collapse problem caused by the difficulty in bearing a supporting force due to the distance being too far when the two are connected. Furthermore, it is defined that the Z coordinate of the at least one candidate adjacent voxel is the same as the Z coordinate of the target secondary voxel, so as to reduce the stress borne by the determined target adjacent voxel, thereby superior forming a support model having a supporting force and superior supporting the three-dimensional model. It also ensures that the search for a voxel is carried out sideways after being blocked downwards, rather than in other directions such as upwards, thus ensuring the smooth execution of the method.

The target voxel vertex is determined from the at least one candidate voxel vertex. The objective of determining the target voxel vertex is achieved. The manner of determining the target voxel vertex from the at least one candidate voxel vertex is not limited, and may be adaptively set according to the actual experience and scenario.

It should be noted that, in cases where the type result is that the voxel type of the target secondary voxel is the blocking voxel type, and after determining at least one candidate neighboring voxel corresponding to the target secondary voxel, if the target adjacent voxel is not able to be determined from the at least one candidate adjacent voxel, that is, when the secondary source cannot be found nearby, merely one original segment of support model may be reserved, and four vertexes at the bottom of the target secondary voxel are connected to the initial three-dimensional model to serve as a truncated support model.

As an optional embodiment, determining a next-level voxel according to whether the voxel type result is a blocking voxel type, until a corresponding voxel with a Z coordinate being a baseplate coordinate is determined, so as to obtain support data corresponding to the three-dimensional model, comprises: in cases where the voxel type of the target secondary voxel is not the blocking voxel type, determining a voxel directly below the target secondary voxel as the lower level voxel, until a corresponding voxel with a Z coordinate being a baseplate coordinate is determined, so as to obtain the support data.

The present embodiment explains the step of determining the support data in cases where the type result is that the voxel type of the target secondary voxel is not the blocking voxel type. In this case, it is explained that during the downward search for the next voxel, a vertically downward voxel can be found, i.e. the three dimensional model does not block the target secondary voxel from finding the voxel downwards.

In this case, it can be directly determined that a voxel directly below is the next-level voxel, until a corresponding voxel with a Z coordinate being a baseplate coordinate is determined, so as to obtain the support data. That is, after a voxel directly below is determined as a next-level voxel, the foregoing steps continue to be repeated by taking the next-level voxel as a starting point, i.e. continuing to search downwards. If a non-blocking voxel is still found during the downward search, the voxel below may be taken as the next-level voxel to continue the search, and so on; this process will be repeated until a corresponding voxel with a Z coordinate being a baseplate coordinate is determined, so as to obtain final support data.

By means of the method, a voxel directly below is able to be directly found as a next-level voxel without blocking, so that the determination of a voxel is more convenient, and finally, the support model can fall to the base, so that the support model supporting the three-dimensional model has a supporting force. In addition, by means of the method, the design of the 3D model support can be optimized, such as reducing redundant supports to decrease material usage, or adding supports to areas with weak stress on the 3D model to reduce the risk of print detachment and improve printing efficiency. It also allows for avoiding the main body of the 3D model, preventing supports from being added to the surface of the model, which could affect the surface quality of model printing.

As an optional embodiment, before the determining a next level of voxel according to whether the voxel type result is a blocking voxel type, until a corresponding voxel with a Z coordinate being a baseplate coordinate is determined, so as to obtain support data corresponding to the three-dimensional model, the method further comprises: in cases where the support point include a support point on an outer surface of the three-dimensional model and a support point on an inner surface of the three-dimensional model, and the baseplate coordinate comprises a first baseplate coordinate and a second baseplate coordinate, determining the first baseplate coordinate corresponding to the support point on the outer surface of the three-dimensional model, and determining the second baseplate coordinate corresponding to the support point on the inner surface of the three-dimensional model, wherein the first baseplate coordinate is a minimum coordinate of the three-dimensional model in the Z-axis direction, and the second baseplate coordinate is a minimum coordinate of the three-dimensional model in the Z-axis direction.

In the present embodiment, the step of determining the baseplate coordinate is described. The steps for determining the baseplate coordinate in two different cases are explained separately. Firstly, in cases where the support points include a support point on an outer surface of the three-dimensional model and a support point on an inner surface of the three-dimensional model, the baseplate coordinates corresponding thereto respectively are determined separately.

First of all, it should be noted that the support point on an outer surface of the three-dimensional model is easy to understand, it refers to the support points on the exterior of the model for supporting the model. The support point on an inner surface of the three-dimensional model is the support point on the interior of the model, that is, some three-dimensional models are very large, in order to save materials and unnecessary consumption resources, the interior of the model may not be printed as solid, that is, the interior is hollow, and when the hollow space of the interior is large, support is also required inside to prevent internal collapse. Therefore, the inner surface of the model also needs to have some support points. By determining the described support points, the design of the support of the three-dimensional model can be optimized, supports may be added to areas with weak stress on the 3D model to reduce the risk of print detachment, while avoiding the addition of supports on the surface of the model, which could affect the surface quality of the model printing.

Based on this, the corresponding acquisition manners of baseplate coordinates will be described.

The first baseplate coordinate corresponding to the support point on an outer surface of the three-dimensional model is determined; the first baseplate coordinate is the minimum coordinate in the Z-axis direction of the 3D model, that is, it can be understood that the first baseplate coordinate is the coordinate of the base on which the 3D model is placed.

It should be noted that, in some cases, to superior obtain the 3D model, the 3D model may be subjected to overhang printing, and when the model needs to be subjected to overhang printing, the first baseplate coordinate is the Z-coordinate plus the height of the overhanging. In this way, a superior three-dimensional model can be printed.

A second baseplate coordinate corresponding to the support point on an inner surface of the three-dimensional model is determined, the second baseplate coordinate being the minimum coordinate of the hollow space in the three-dimensional model in the direction of the Z axis. That is, the coordinates of the second bottom plate is the coordinates of the lowest point of the inner hollow space, and in this way, it can achieve a superior supporting effect inside.

As an optional embodiment, determining the target voxel vertex corresponding to the support point comprises: determining at least one candidate voxel vertex corresponding to the support point, wherein the distance between the candidate voxel vertex and the support point is less than a second predetermined threshold; and determining the target voxel vertex from the at least one candidate voxel vertex.

In the present embodiment, the step of determining a target voxel vertex corresponding to the support point is described. At least one candidate voxel vertex corresponding to the support point is determined first, wherein the distance between the at least one candidate voxel vertex and the support point is less than a second predetermined threshold, which ensures that the distance between the at least one candidate voxel vertex and the support point is relatively short, and avoids the collapse problem caused by the difficulty in bearing a supporting force due to an excessive distance when the two are connected.

The target voxel vertex is determined from the at least one candidate voxel vertex. The objective of determining the target voxel vertex is achieved. The manner of determining the target voxel vertex from the at least one candidate voxel vertex is not limited, and may be adaptively set according to the actual experience and scenario.

As an optional embodiment, determining the target voxel vertex from the at least one candidate voxel vertex comprises: determining the number of supports relating to every one of the at least one candidate voxel vertex is supported; and determining the target voxel vertex from the at least one candidate voxel vertex according to the number of supports relating to every one of the at least one candidate voxel vertex is supported.

In the present embodiment, the number of supports relating to every one of at least one candidate voxel vertex is supported is determined, and the number of supports relating to the current voxel vertex is supported may be calculated by means of an independent counter, so as to determine the target voxel vertex from the at least one candidate voxel vertex according to the number of supports relating to every one of the at least one candidate voxel vertex is supported.

Since the number of supports relating to a voxel vertex is supported can indirectly reflect the support strength of the voxel vertex, that is, it can indicate whether it is stable, the target voxel vertex can be determined on the basis of the number of supports relating to the voxel vertex is supported.

In a three-dimensional representation, if the number of supports relating to the voxel vertex is less than or equal to a predetermined threshold, for example, the predetermined threshold may be set to 2 in a scenario applied in the present disclosure, it is considered that the point is not in a stably supported state, and the point is considered not to be a target voxel vertex. If the predetermined threshold is greater than 2, the point is considered to be in a stably supported state and can preliminarily be regarded as a target voxel vertex. In this way, the stability of the determined target voxel vertex can be ensured.

As an optional embodiment, determining the target voxel vertex from the at least one candidate voxel vertex comprises: determining the connection parameters for at least one connecting rod connecting the candidate voxel vertex to the support points; and determining the target voxel vertex from the at least one candidate voxel vertex according to the connection parameters for at least one connecting rod connecting the candidate voxel vertex to the support points.

In the present embodiment, the connection parameters for at least one connecting rod connecting the candidate voxel vertex to the support points are determined, so that the target voxel vertex is determined from the at least one candidate voxel vertex according to the connection parameters for at least one connecting rod connecting the candidate voxel vertex to the support points.

The connection parameters may be a length, an angle, and the like of a connection between the two, and may be adaptively set according to an actual application and scenario.

The stability varies due to different connection parameters, the support strength of the voxel vertex is reflected by the connection parameters, which means that it can indicate whether it is stable. Therefore, the target voxel vertex may be determined on the basis of the connection parameters between the voxel vertex and the support point.

In a three-dimensional representation, if the angle in the connection parameter is too large, it is considered that the connection between the two may not be in a stablly supported state, and the point is considered as not being able to serve as the target voxel vertex. If the angle is within a preset range, it is considered that the connection between the two may be in a stablly supported state, and the point can be preliminarily regarded as a target voxel vertex. In this way, the stability of the determined target voxel vertex can be ensured.

As an optional embodiment, the determining, from the plurality of voxels, a target source voxel relating to the target voxel vertex comprises: determining, from the plurality of voxels, at least one candidate source voxel relating to the target voxel vertex, wherein a Z coordinate of the at least one candidate source voxel is less than or equal to the Z coordinate of the target voxel vertex; and determining the target source voxel from the at least one candidate source voxel.

The present embodiment describes the step of determining, from the plurality of voxels included in the voxel space, a target source voxel relating to the target voxel vertex. A target voxel vertex may have up to eight neighboring voxels (for example, in a 2×2×2 voxel set, i.e. four voxels on the upper portion and four voxels on the lower portion). Since the support model is built downward from the support point, the target source voxel may be determined from the four voxels of which the Z-coordinates are lower than those of others. Therefore, the number of supports relating to every one of the at least one candidate source data may be set to be four. When the number is set to be four, the calculation amount can be reduced, and the process of the method provided in the present disclosure is quickened.

In addition, when determining candidate source voxels on the basis of the target voxel vertex, it is not necessary to restrict the target voxel vertex to lie directly on the candidate source voxel. Instead, a distance-based constraint may be used to broaden the selection criteria for selecting the candidate source voxel. That is, it is not necessary to use only the voxels directly connected to the target voxel vertex as the starting point for determining the support model downwards; the source voxel may be located farther away and combined with other support points into a single target source voxel, from which the support model can then be searcher for downwards, thereby saving printing resources to a certain extent.

It should be noted that the at least one determined candidate source voxel may have a Z coordinate less than or equal to a Z coordinate of the vertex of the target voxel, that is, it is defined that the determined target source voxel is searched for downwards, and therefore, when the support point is connected to the target source voxel, the support point is connected downwards to the target source voxel, providing a certain supporting force, rather than being connected upwards, which offers a limited supporting force.

The method for determining the target source voxel from at least one candidate source voxel is not limited here and may be performed with the aim of having a supporting power greater than a predetermined threshold and saving printing resources. When there are a plurality of support bodies, if adjacent support bodies is able to correspond to the same target source voxel, the target source voxel may be taken as a source to search for a voxel downwards to construct the support body, that is, a plurality of support bodies are originally needed, but by corresponding them to a single target source voxel, only one support body is required, which can save printing resources. Therefore, the above beneficial effects can be achieved with the aim of saving printing resources while ensuring the supporting force.

As an optional embodiment, after the determining a target source voxel from the plurality of voxels, the method further comprises: determining whether a target secondary voxel corresponding to the target source voxel exists in a negative direction of the Z axis; and in cases where the target secondary voxel corresponding to the target source voxel doesn't exist, determining data of a connecting rod connecting the support point to the predetermined surface.

In the present embodiment, whether the target secondary voxel corresponding to the target source voxel exists in the negative direction of the Z axis is determined, so as to perform targeted processing with respect to different determination results. In cases where the target secondary voxel corresponding to the target source voxel doesn't exist, i.e., if a secondary voxel of at least one voxel height is able to be generated from the beginning, then a segment of connecting rod is generated, and the end is connected to the surface of the object to obtain the connecting rod data, i.e., to obtain the connecting rod data connected to a predetermined surface by the support point. The angle of the connection parameters may be an angle between the connecting rod and an level plane where the candidate voxel vertex is located. The predetermined surface is the described surface of the object. The specific point on the surface to which the connection is made can be customized on the basis of the actual application and scenario, such as the point directly vertically downward from the support point. In this way, the processing manner in cases where the determination result is that the target secondary voxel corresponding to the target source voxel cannot be determined is described, and the applicability of the present solution is broadened.

As an optional embodiment, the shape of the connecting rod represented by the connecting rod data is hemispherical at both ends and cylindrical in the middle.

In this way, the shape of the connecting rod represented by the connecting rod data is defined. The connecting rod has a shape consisting of hemispheres on both sides connected by a cylindrical tube in the middle, ensuring stability while saving resources and facilitating easy disassembly.

It should be noted that, in the present disclosure, the forms of the connector and the connecting rod may also be customized to meet different customization requirements.

As an optional embodiment, the support point and the target voxel data are connected to each other by a conical frustum connector, the conical frustum connector comprises a tip and a bottom surface, the tip is connected to the support point, and the bottom surface is connected to the target voxel data.

In the present embodiment, the connection manner between the support point and the target voxel data is described, and in this case, a conical frustum connector may be provided for connecting the support point and the target voxel represented by the target voxel data. In this case, it can be understood that only one point is connected to the model, and one bottom surface is connected to the target voxel, which allows for saving printing materials while ensuring stability, and also makes the 3D model easier to be disassembled.

As an optional embodiment, a radius of the bottom surface is equal to a cylindrical radius corresponding to the target voxel data.

In the present embodiment, it is defined that the conical frustum connector and the target voxel correspond to the same cylindrical radius, and therefore, it can be guaranteed that the conical frustum connector is fully connected to the target voxel, and the stability of the connection is guaranteed.

As an optional embodiment, the voxel is a hollow-type voxel, and a target surface of the voxel is formed by two cylinders intersecting diagonally.

The voxels may be have various types, such as solid-type voxels; however, in the present embodiment, it is defined that the voxels are hollow-type voxels, that is, the voxel is not an entire cube, but is a hollow structure having a supporting force, and the target surface is a surface related to the supporting force, for example, for a voxel with a supporting force in only one direction, two cylinders of a specific radius are used to connect two pairs of diagonal points on each of the four squares perpendicular to the direction of the supporting force, thereby forming a physical representation of the voxel. On the one hand, a supporting force can be provided, and on the other hand, printing resources and printing time are greatly saved. That is, not only the consumption of the material during printing can be reduced, it is also defined that the target surface is formed by two cylinders intersecting diagonally, thereby guaranteeing the supporting force and stability of the voxel.

As an optional embodiment, a resolution of the voxel is greater than a radius of the cylinder by a predetermined multiple.

In the present embodiment, it is defined that the resolution of the voxel is greater than a predetermined multiple of the radius of the cylinder. This is to prevent the cylinders between pairs of voxels from occupying excessive space, which could cause the surface of one cylinder to embed into an adjacent cylinder. Therefore, the resolution of the voxel needs to be greater than a predetermined multiple of the radius of the cylinder, for example, in the context of the present disclosure, it may be set to 8 times, and this value can be customized as needed.

As an optional embodiment, the radius of the cylinder is determined according to a distance between the corresponding voxel and the three-dimensional model and a collision probability corresponding to the distance.

In the present embodiment, since the voxels have a certain volume, the voxels are likely to collide with the three-dimensional model. Therefore, when the radius of the cylinder in the voxel is determined, the collision probability with the physical object within the maximum radius of the voxel is required, and in the case of possible collision, the radius may be further reduced to avoid collision. Thus, three-dimensional printing can achieve a superior result.

An optional implementation is provided on the basis of the foregoing embodiments and optional embodiments, and is specifically described in the following.

The optional embodiment of the present disclosure provides a method for determining support data of a three-dimensional model. The method proposes a segmented support model, which establishes self-supporting nodes at regular intervals by controlling the length of each cylindrical segment, enhancing the self-supporting capability of each segment against other stresses, thereby enabling the support structure to support three-dimensional objects farther from low potential energy.

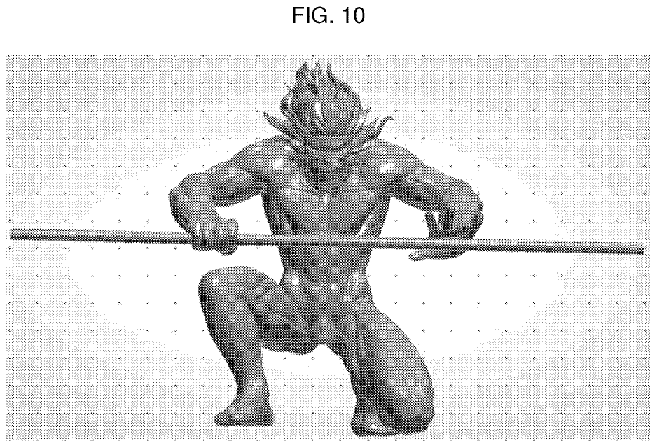

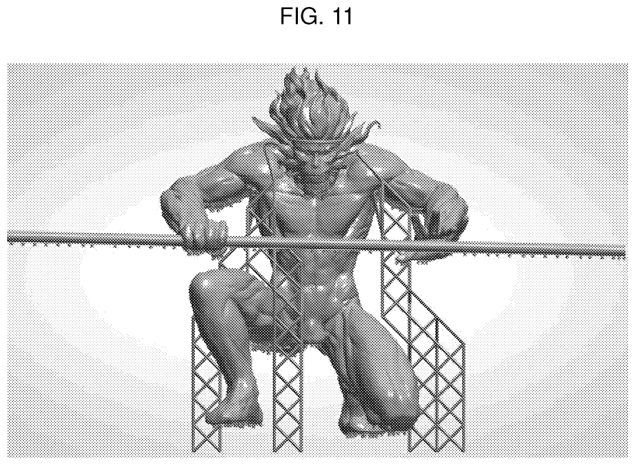

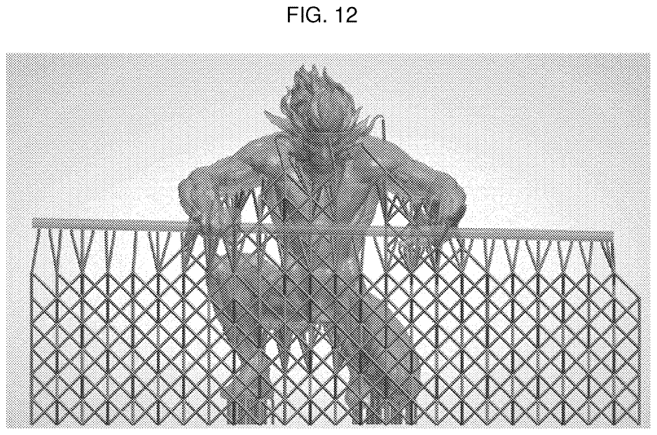

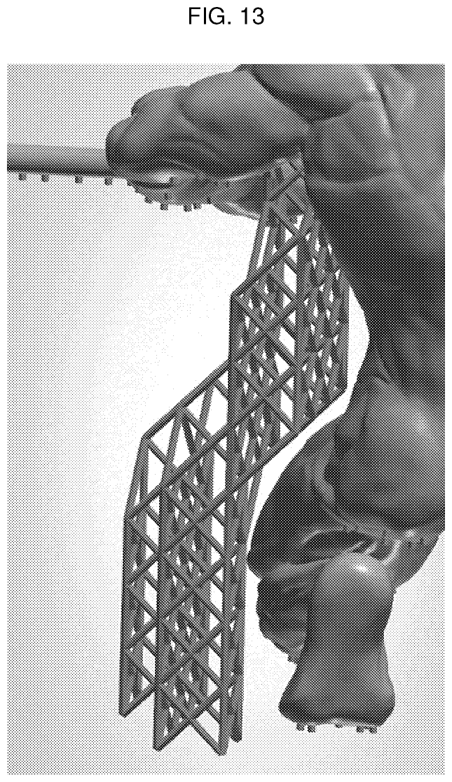

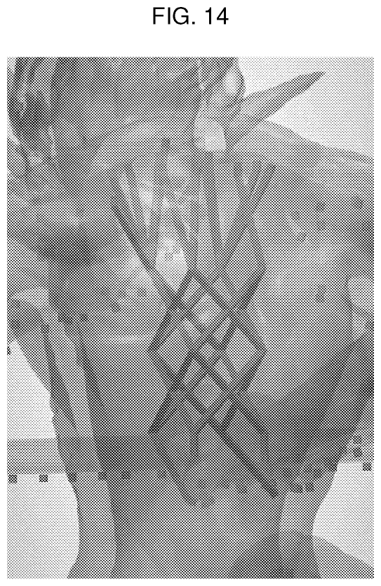

FIG. 10 is a schematic diagram of a model according to an optional implementation of the present disclosure; FIG. 11 is a schematic diagram of a part of a flowing voxel waterfall (support model) of an outer surface of a model according to an optional implementation of the present disclosure; FIG. 12 is a schematic diagram of a flowing voxel waterfall (support model) of an outer surface of a model according to an optional implementation of the present disclosure; FIG. 13 is a schematic diagram of a local flow voxel waterfall on an outer surface of a model according to an optional implementation of the present disclosure; FIG. 14 is a schematic diagram of a local flow voxel waterfall within a model according to an optional implementation of the present disclosure, which are described in detail below:
step S1: a three-dimensional model is acquired, wherein the three-dimensional model is located in a voxel space formed by an X axis, a Y axis and a Z axis, the voxel space comprising a plurality of voxels;
the entire 3D model (i.e., the object to be printed) is enclosed using several voxels. Voxels contacting the object to be printed are referred to as blocking voxels, and the others are referred to as unblocking voxels.

Voxels included in a voxel space are hollow-type voxels, a target surface of the voxel is formed by two cylinders intersecting diagonally, and the target surface is a surface related to a supporting force. More specifically, for a voxel with a supporting force in only one direction, two cylinders of a specific radius are used to connect two pairs of diagonal points on each of the four squares perpendicular to the direction of the supporting force, thereby forming a physical representation of the voxel. For example, as shown in FIG. 14, the two relatively regular cubes in the middle represent the two illustrated voxels.

In addition, the voxel size may be set by the parameter, and it is assumed that the voxel under this parameter is not subjected to stresses other than gravity. The voxels generated in the first step are stacked in the direction opposite to gravity. Under the assumption of the first step, in the stacked voxels, the upper voxels are fully supported by the lower voxels. The support stacked in this manner can distribute, at each segment (the diagonal points of the four surfaces of each voxel perpendicular to the direction of the force are connected to cylinders), the influence of other forces on the current voxel block, thereby reducing supporting deformation and fracture.

S2: a support point corresponding to the three-dimensional model is acquired.

As shown in FIG. 10, the short cylinders in the figure are support points. The voxel waterfall that avoids the thigh portion is a support model consisting of the target source voxel connecting to the support points, a target secondary voxel, a plurality of next-level voxels, until a voxel with a corresponding Z coordinate being a baseplate coordinate is determined.

S3: at least one candidate voxel vertex corresponding to the support point is determined, wherein the distance between the at least one candidate voxel vertex and the support point is less than a second predetermined threshold.

S4: the connection parameters for at least one connecting rod connecting the candidate voxel vertex to the support points are determined.

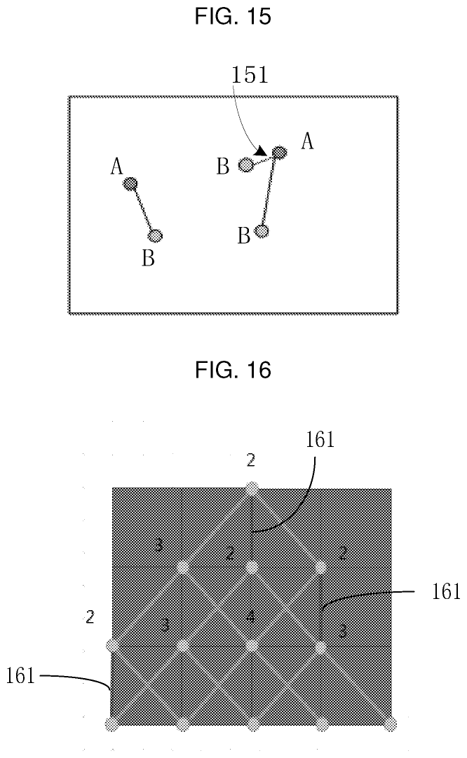

FIG. 15 is a schematic diagram of a relationship between a support point and a voxel according to an optional implementation of the present disclosure. As shown in FIG. 15, point A represents a support point or a support anchor point, point B represents a voxel vertex, and a line connecting the point A and point B may represent a connection-related parameter. A target voxel vertex may be determined therefrom according to the connection parameter of the candidate voxel vertex, for example, the parameter connecting voxels during printing. As shown in the figure, the line segment 151 pointed to by the arrow indicates that this segment of support is too short and too slanted, so in some cases, the corresponding candidate voxel vertex will not be selected as the target voxel vertex.

S5: the number of supports relating to every one of the at least one candidate voxel vertex is supported is determined.

FIG. 16 is a schematic diagram of corresponding supported times of voxels according to an optional implementation of the present disclosure. As shown in FIG. 16, a target voxel vertex may be determined according to the number of supports relating to every one of the candidate voxel vertexes are supported. In order to express a physical object of a voxel, the surfaces around each voxel are expressed using intersecting connection relationships, primarily diagonal connections. In addition to the intersecting expression, there is also a separate counter for calculating the number of supports that the current voxel vertex is supported; and in a three-dimensional representation, if the number of supports of a voxel vertex is less than or equal to 2, it is considered that the point is not in a stablly supported state, and therefore, an attempt is made in the vertical direction to search for a vertex to be connected to the next segment for connection. When the number of supports that the current voxel vertex is supported is greater than 2, for example, the current voxel vertex is supported three times and four times, it is unnecessary to search in the vertical direction for a vertex to be connected to the next segment for connection. Referring to FIG. 16, starting from the positive direction along the Z axis to the negative direction, it can be observed that some voxel vertices are supported 2 times, some voxel vertices are supported 3 times, and some voxel vertices are supported 4 times. For voxel vertices supported 2 times, a search is made in the vertical direction to find a vertex to be connected to the next segment for connection, such as a line segment 161 in the figure.

S6: a target voxel vertex is determined from the at least one candidate voxel vertex according to the connection parameters for at least one connecting rod connecting the candidate voxel vertex to the support points and the number of supports relating to every one of the at least one candidate voxel vertex is supported, wherein the Z coordinate of the at least one candidate source voxel is less than or equal to the Z coordinate of the target voxel vertex.

S7: at least one candidate source voxel relating to the target voxel vertex is determined from a plurality of voxels included in a voxel space.

During each step of the implementation process, the information about whether the voxel grid connected to each voxel vertex is blocked is stored; until the downward flow begins, the algorithm can determine whether the next voxel is blocked, thereby guiding the direction of the next flowing voxel.

It should be noted that, certainly, the blocking may start from the source of the waterfall. Therefore, it is also necessary to consider whether the support point is located in a narrow region, which would prevent it from flowing downward.

S8: the target source voxel is determined from the at least one candidate source voxel.

S9: in a negative direction of the Z axis, a target secondary voxel corresponding to the target source voxel is determined.

S10: a next-level voxel is determined according to a type result about whether the voxel type of the target secondary voxel is a blocking voxel type;

1) in cases where the type result is that the voxel type of the target secondary voxel is the blocking voxel type, and FIG. 17 is a schematic diagram illustrating the direction of a voxel when the voxel type of the target secondary voxel is a blocking voxel type according to an optional implementation of the present disclosure, as shown in FIG. 17, an introduction is given below:
determining at least one candidate adjacent voxel corresponding to the target secondary voxel, wherein a Z coordinate of the at least one candidate adjacent voxel is the same as a Z coordinate of the target secondary voxel, and the distance between the at least one candidate adjacent voxel and the target secondary voxel is less than a first predetermined threshold;
determining the target adjacent voxel from the at least one candidate adjacent voxel, wherein a Z coordinate of the target adjacent voxel is the same as a Z coordinate of the target secondary voxel;
determining the next-level voxel by taking the target adjacent voxel as a new source voxel, until a voxel with a corresponding Z coordinate being a baseplate coordinate is determined, so as to obtain the support data, wherein the baseplate coordinate is a minimum coordinate of the three-dimensional model in the direction of the Z axis.
and 2) in cases where the voxel type of the target secondary voxel is not the blocking voxel type, determining a voxel directly below the target secondary voxel as the lower level voxel, until a voxel with a corresponding Z coordinate being a baseplate coordinate is determined, so as to obtain the support data.

During the implementation process of the first step, the information about whether the voxel grid connected to each voxel vertex is blocked is stored; until the downward flow begins, the algorithm can determine whether the next voxel is blocked, thereby guiding the direction of the next flowing voxel. Certainly, the blocking may start from the source of the waterfall. Therefore, it is also necessary to consider whether the support point is located in a narrow region, which would prevent it from flowing downward.

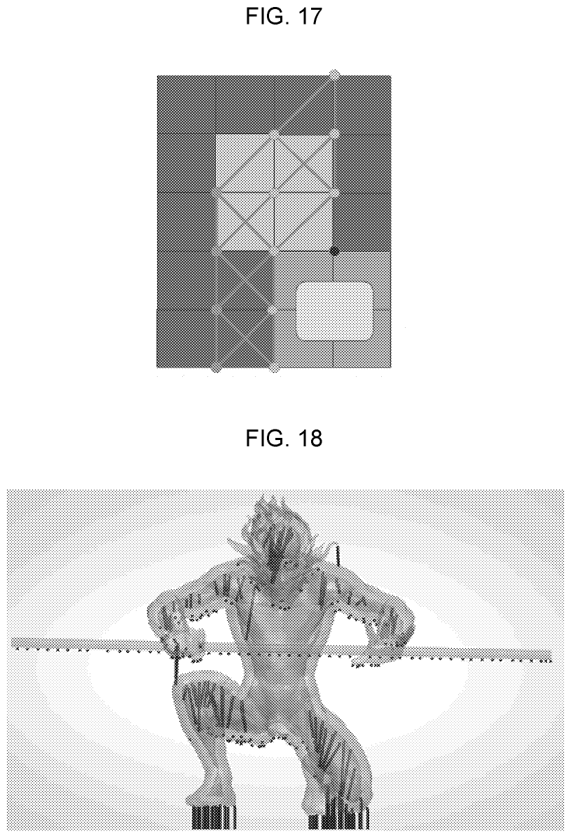

It should be noted that, in cases where the type result is that the voxel type of the target secondary voxel is the blocking voxel type, and in cases where the target adjacent voxel cannot be determined from the at least one candidate adjacent voxel after at least one candidate adjacent voxel corresponding to the target secondary voxel is determined, FIG. 18 is a schematic diagram of a connector connected to the surface of an object according to an optional implementation of the present disclosure, as shown in FIG. 18, that is, when the secondary source cannot be found nearby, merely the original segment of waterfall may be reserved, and at the end of the waterfall, four vertexes at the bottom of the voxel are connected to the object to be printed to serve as a truncated waterfall support. If pwf of at least one voxel height cannot be generated from the outset, then only a segment of connecting rod is generated, and the end is connected to the surface of the object.

S11: until a voxel with a corresponding Z coordinate being a baseplate coordinate is determined, support data corresponding to the three-dimensional model is obtained.

It should be noted that, it has been stated above, in cases where the support point include a support point on an outer surface of the three-dimensional model and a support point on an inner surface of the three-dimensional model, and the baseplate coordinate comprises a first baseplate coordinate and a second baseplate coordinate, determining the first baseplate coordinate corresponding to the support point on the outer surface of the three-dimensional model, and determining the second baseplate coordinate corresponding to the support point on the inner surface of the three-dimensional model, wherein the first baseplate coordinate is a minimum coordinate of the three-dimensional model in the Z-axis direction, and the second baseplate coordinate is a minimum coordinate of the hollow space inside the three-dimensional model in the Z-axis direction.

FIG. 13 is a schematic diagram of establishing a voxel waterfall at the exterior of a model, and FIG. 14 is a schematic diagram of establishing a voxel waterfall at the interior of a model. After the support data is determined, a printing data is determined, wherein the represented three-dimensional model is shown in FIG. 12.

It should be further noted that, in the foregoing processing process, simplified processing may be performed on the voxels. That is, during actual printing, for areas far from the support anchor points, such as the end region of the model, if the connection is on the baseplate, a certain degree of simplification process may be applied. If a vertical or flowing pwf cannot be generated, the only solution is to connect the four vertices at the bottom of the pwf segment to the surface of the object, to support this disconnected pwf segment.

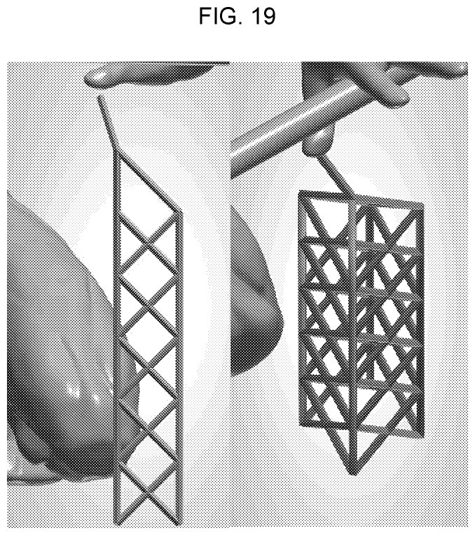

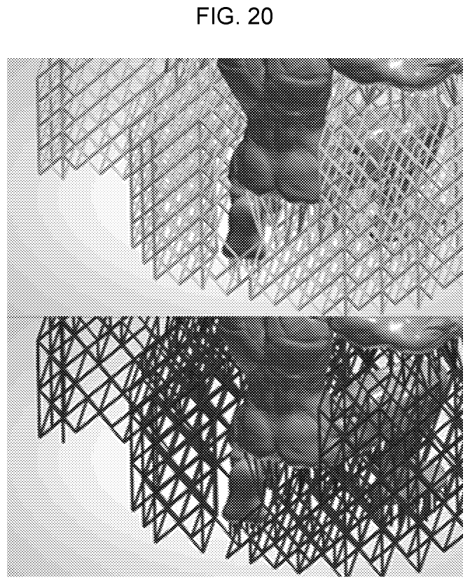

FIG. 19 is a comparison diagram between simplified voxel data and non-simplified voxel data according to an optional implementation of the present disclosure, and in the figure, the left part is a simplified schematic diagram, and the right part is an unsimplified schematic diagram. FIG. 20 is a comparison diagram between simplified model overall voxel data and non-simplified model overall voxel data according to an optional implementation of the present disclosure, and in the figure, the upper part is an unsimplified schematic diagram, and the lower half part is a simplified schematic diagram. As shown in FIG. 19, by means of simplification, the waste of material can be reduced on the basis of the support model.

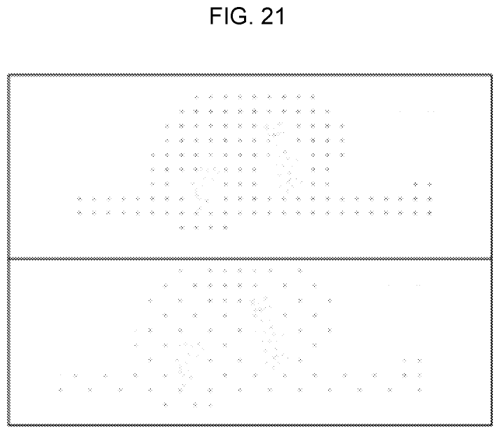

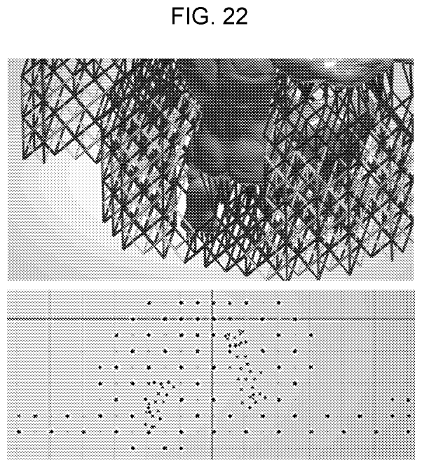

FIG. 21 is a schematic diagram of simplification and non-simplification of voxel data comprising printing data according to an optional implementation of the present disclosure. It can be determined from the upper right part of the figure that the data required to be printed is relatively dense, and it can be determined from the lower right part of the figure that the data required to be printed is relatively sparse, which can effectively reduce material consumption. To provide a more intuitive demonstration, FIG. 22 is an overlapping comparison diagram of voxel data according to an optional implementation of the present disclosure, and it can be clearly known from FIG. 22 how much material is saved in the simplified version.

FIG. 23 is a schematic diagram of connector components according to an optional implementation of the present disclosure. In the solution provided in the optional implementation of the present disclosure, the connector component may be predetermined and manufactured directly, that is, the connection of voxels may be achieved by means of the connector component in the figure, that is, voxel data may be obtained by splicing, so that more efficient processing can be achieved when a model is really printed. The skeleton (all being line segments, with no three-dimensional entities) with vertices connected to vertices is described above. The basic method for physically representing a line segment is to add a radius, transforming the line segment into a pipeline. Due to the flow pattern requirements of the three-dimensional model, it is necessary to pre-calculate, at intersections, the connection vertex information on the three-dimensional grid.

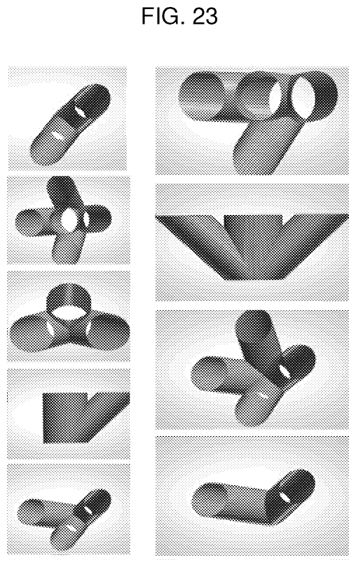

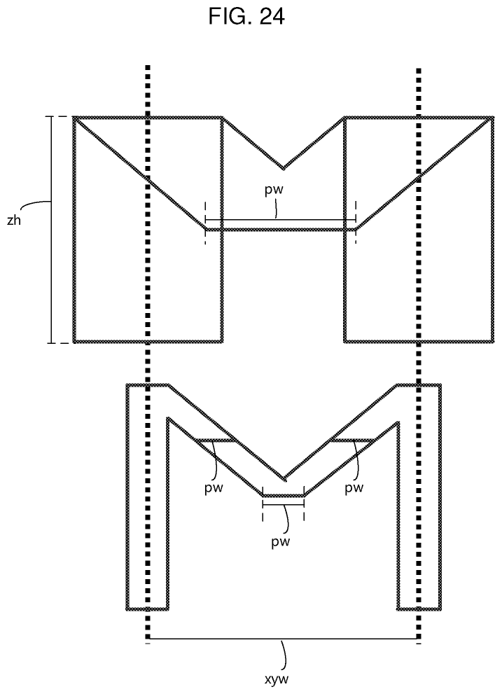

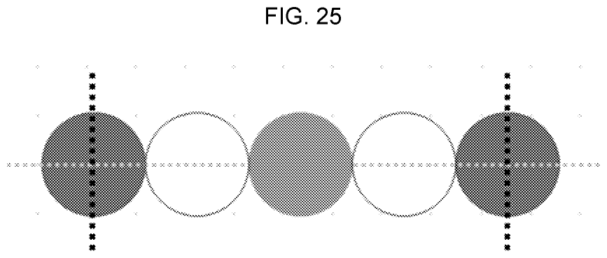

FIG. 24 is a comparison diagram when the resolutions of voxels are different according to an optional implementation of the present disclosure; FIG. 25 is a schematic cross-sectional diagram when the voxel resolution is equal to eight times the radius of the cylinder according to an optional implementation of the present disclosure; it can be determined from the figure that the pipe width (abbreviated as pw) is used herein to represent different resolutions, wherein pwf xy width (abbreviated as xyw) represents the width and length of a pixel grid, while pwf z width (abbreviated as zh) represents the height of a pixel grid; it can be determined from FIG. 24 that, when the voxel resolution is too low, it leads to severe intersection of connectors, causing certain limitations; it can be determined from FIG. 25 that when the voxel resolution is greater than a predetermined multiple, such severe intersection does not occur. Therefore, by defining that the voxel resolution is greater than a predetermined multiple of the radius of the cylinder, it prevents the cylinders corresponding to the pairs of voxels from occupying excessive space, which could cause the surface of one cylinder to embed into an adjacent cylinder. Therefore, the resolution of the voxel needs to be greater than a predetermined multiple of the radius of the cylinder.

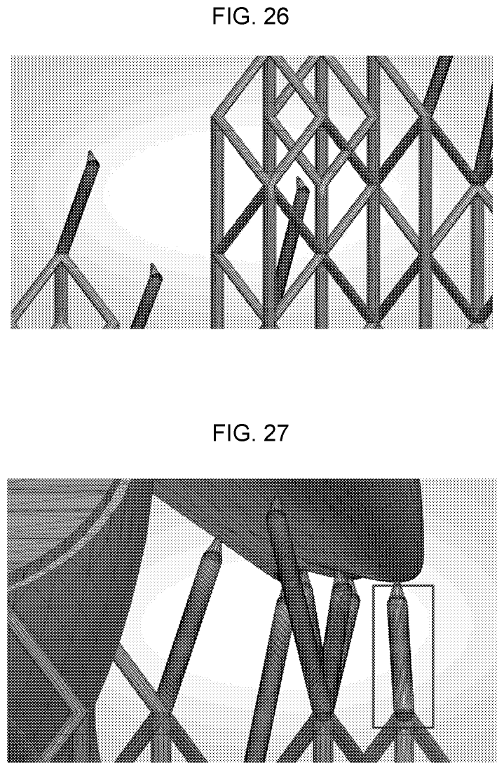

FIG. 26 is a schematic diagram that comprises a conical frustum connector according to an optional implementation of the present disclosure; FIG. 27 is a schematic diagram that comprises another conical frustum connector according to an optional implementation of the present disclosure; FIG. 28 is a schematic diagram that labels a conical frustum connector according to an optional implementation of the present disclosure; the conical frustum connector describes a connection manner between a support point and target voxel data, i.e., a truncated circular connector is provided for connecting the support point and the target voxel represented by the target voxel data. In this case, it can be understood that only one point is connected to the model, and one bottom surface is connected to the target voxel, which allows for saving printing materials while ensuring stability, and also makes the 3D model easier to be disassembled.

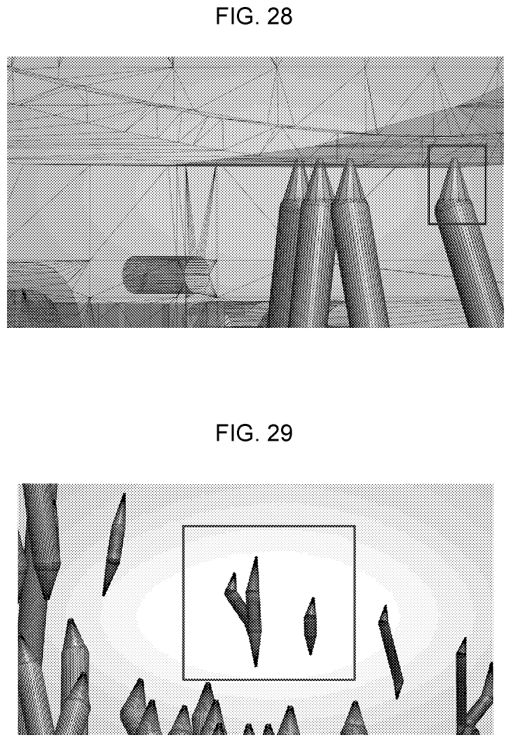

It should be noted that, the connector may also be shown in FIG. 29. FIG. 29 is a schematic diagram of a connector according to an optional implementation of the present disclosure. In some embodiments, the connector may be a cylindrical body with conical ends or spherical ends. This design defines the shape of the connecting rod represented by the connecting rod data, ensuring stable support for the model while saving resources and facilitating easier disassembly. This design allows it to superior avoid collisions with the physical object. The form of the specific connector can be selected adaptively according to a specific model or the position of the connector.

It should be noted that, in the present disclosure, the forms of the connector and the connecting rod may also be customized to meet different customization requirements.

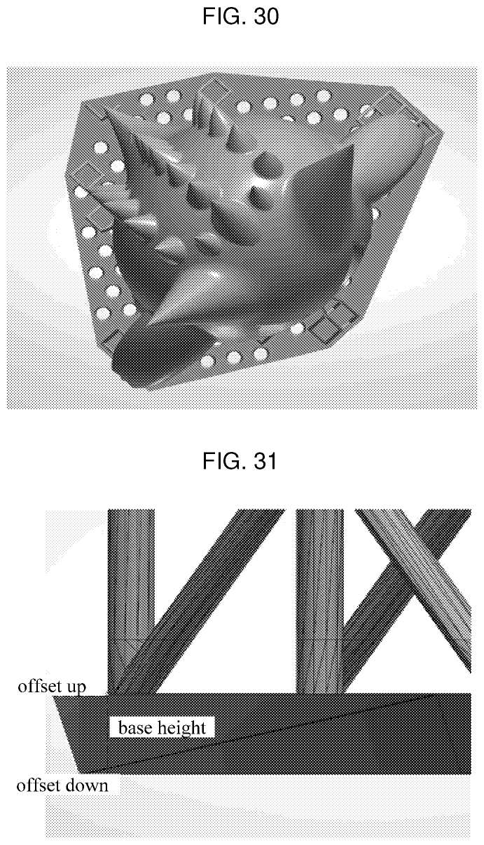

FIG. 30 is a top view of a mold according to an optional implementation of the present disclosure; it can be seen from the figure that the model comprises a baseplate, the shape of the baseplate is determined by the shape of the convex hull enclosed by all the cylindrical coordinates connected to the base; the longest edge of the convex hull is used as the X axis, with the orthogonal direction as the Y axis, forming a local coordinate system that serves as the starting coordinate for the center of the hollowed circles of the baseplate. By forming these hollowed circles, the normal operation of 3D model printing is ensured, preventing issues such as liquid retention.

FIG. 31 is a schematic diagram of a base according to an optional implementation of the present disclosure. By providing the base, the process of moving the model out of the printing region can be made more effortless. It designs a chamfer on the baseplate, using three parameters, i.e., base height, offset up and offset down, to control the angle of the chamfer: an upper offset, a lower offset and the height of the base plate, respectively. In this way, the above effect can be achieved by means of the chamfer on the baseplate.

By means of the described optional implementation, at least the following beneficial effects can be achieved: by means of the described steps, voxels for supporting are determined level by level, so that when a three-dimensional model is printed according to printing data, the support condition of the printed three-dimensional model is more stable, thereby solving the technical problem in the related art that when a three-dimensional model is printed according to three-dimensional printing data comprising support data, the support condition of the printed three-dimensional model is unstable. In addition, by means of the method, the design of the 3D model support can be optimized, such as reducing redundant supports to decrease material usage, or adding supports to areas with weak stress on the 3D model to reduce the risk of print detachment and improve printing efficiency. It also allows for avoiding the main body of the 3D model, preventing supports from being added to the surface of the model, which could affect the surface quality of model printing.

It should be noted that, for ease of description, the foregoing method embodiments are stated as a combination of a series of actions. However, a person skilled in the art is to know that the present disclosure is not limited to the described action sequence, because according to the present invention, some steps may be performed in another sequence or simultaneously. Secondarily, a person skilled in the art knows that the embodiments described in the specification all belong to example embodiments and the involved actions and modules are not necessary for the present disclosure.

From the description of the described embodiments, a person skilled in the art would have been able to clearly understand that the method in the described embodiments may be implemented by using software and necessary general hardware platforms, and of course may also be implemented using hardware, but in many cases, the former is a superior embodiment. Based on such understanding, the essence of technical solution of the embodiments of the present disclosure, or in other words, the part of the technical solutions making contributions to the prior art, may be embodied in the form of a software product stored in a storage medium (such as a Read-Only Memory (ROM)/Random Access Memory (RAM), a magnetic disk and an optical disc), comprising a number of instructions for enabling a terminal device (which may be a mobile phone, a computer, a server, or a network device, etc.) to perform the methods described in various embodiments of the present disclosure.

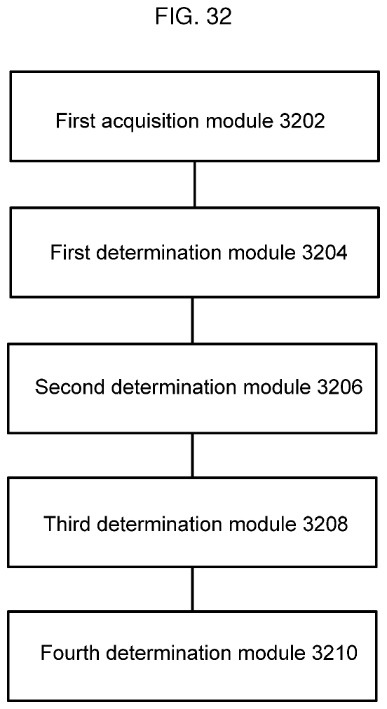

According to an embodiment of the present disclosure, an apparatus for implementing the method for determining support data of the three-dimensional model is further provided, FIG. 32 is a structural block diagram of an apparatus for determining support data of a three-dimensional model according to an embodiment of the present disclosure; as shown in FIG. 32, the apparatus comprises a first acquisition module 3202, a first determination module 3204, a second determination module 3206, a third determination module 3208 and a fourth determination module 3210, and the apparatus is described in detail below.

The first acquisition module 3202 is configured to acquire a three-dimensional model, wherein the three-dimensional model is located in a voxel space formed by an X axis, a Y axis and a Z axis, the voxel space comprising a plurality of voxels; the first determination module 3204 is connected to the first acquisition module 3202 and is configured to determine a target source voxel from the plurality of voxels; the second determination module 3206 is connected to the first determination module 3204 and is configured to determine, in a negative direction of the Z axis, a target secondary voxel corresponding to the target source voxel; the third determination module 3208 is connected to the second determination module 3206 and is configured to perform voxel type determination on the target secondary voxel, and determine a voxel type result of the target secondary voxel; and the fourth determination module 3210 is connected to the third determination module 3208 and is configured to obtain support data corresponding to the three-dimensional model according to the voxel type result.

It should be noted here that, the first determination module 3204, the second determination module 3206, the third determination module 3208 and the fourth determination module 3210 correspond to step S902 to step S910 in the method for determining support data for implementing the three-dimensional model, and examples and application scenarios implemented by a plurality of modules are the same as those of corresponding steps, but are not limited to the content disclosed in the above embodiments.

Provided is an electronic device, comprising: one or more processors, a memory, and one or more programs, wherein the one or more programs are stored in the memory and configured to be executed by the one or more processors, and the one or more programs include a method for executing any one of the methods for manufacturing a target object.

Obviously, those skilled in the art should understand that the modules or steps in the present disclosure can be implemented by using a general computing device, and they can be integrated in a single computing device, and can also be distributed over a network consisting of a plurality of computing devices. They may be implemented by using executable program codes of the computing devices. Thus, they can be stored in a storage device and executed by the computing devices. Furthermore, in some cases, the shown or described steps may be executed in an order different from that described here, or they can be respectively implemented by individual Integrated Circuit modules, or they can be implemented by making a plurality of the modules or steps into a single Integrated Circuit module. Hence, the present disclosure is not limited to any specific combinations of hardware and software.

As will be appreciated by a person skilled in the art, embodiments of the present disclosure may be provided as a method, a system, or a computer program product. Therefore, the present disclosure may take the form of entirely hardware embodiments, entirely software embodiments or embodiments combining software and hardware. Furthermore, the present disclosure may take the form of a computer program product implemented on one or more computer-usable storage media (comprising but not limited to a disk memory, a CD-ROM, an optical memory, etc.) containing computer-usable program codes.

Some embodiments of the present disclosure are described with reference to the flowcharts and/or block diagrams of the method, device (system), and computer program product according to the embodiments of the present disclosure. It should be understood that computer program instructions may be used to implement each process and/or block in the flowchart and/or block diagram and a combination of processes and/or blocks in the flowchart and/or the block diagram. These computer program instructions may be provided to a processor of a general-purpose computer, a special-purpose computer, an embedded processor or other programmable data processing devices to produce a machine, such that an apparatus for implementing functions specified in one or more processes in the flowchart and/or one or more blocks in the block diagram is implemented by executing the instructions by the processor of the computer or other programmable data processing devices.

These computer program instructions can also be stored in a computer-readable memory that can direct a computer or other programmable data processing devices to operate in a particular manner, such that the instructions stored in the computer-readable memory produce a product comprising an instruction device, the instruction device implementing functions specified in one or more processes of the flowchart and/or one or more blocks of the block diagram.

These computer program instructions may also be loaded onto a computer or other programmable data processing devices, so that a series of operation steps are executed on the computer or other programmable data processing devices to generate processing implemented by the computer, so that the instructions executed on the computer or other programmable data processing devices provide steps for implementing functions specified in one or more processes in the flowchart and/or one or more blocks in the block diagram.

In a typical configuration, a computing device comprises one or more processors (CPUs), an input/output interface, a network interface, and a memory.

The memory may include forms such as a non-permanent memory, a random access memory (RAM), and/or a non-transitory memory such as a read-only memory (ROM) or a flash RAM, in a computer-readable medium. A memory is an example of a computer-readable medium.

The computer-readable medium, comprising both permanent and non-permanent, and removable and non-removable medium, may achieve information storage by any method or technology. The information may be computer-readable instructions, data structures, modules of a program, or other data. Examples of the computer storage medium include but are not limited to, phase change memory (PRAM), static random-access memory (SRAM), dynamic random-access memory (DRAM), other types of random-access memories (RAM), read-only memory (ROM), electrically erasable programmable read-only memory (EEPROM), flash memory or other memory technology, compact disc read-only memory (CD-ROM), digital versatile disc (DVD) or other optical storage, magnetic cassettes, magnetic tape magnetic disk storage or other magnetic storage devices, or any other non-transmission media, which may be used to store information that may be accessed by the computing device. As defined herein, the computer-readable media do not include transitory computer-readable media, such as modulated data signals and carriers.

It should also be noted that the terms “include”, “includes”, or any other variations thereof are intended to cover a non-exclusive inclusion, so that a process, a method, a commodity, or a device that comprises a series of elements not only comprises those elements, but also comprises other elements that are not explicitly listed, or further comprises inherent elements of the process, the method, the commodity, or the device. Without further limitation, an element defined by a sentence “include a . . . ” does not exclude other same elements existing in a process, a method, a commodity, or a device that comprises the element.

The described content merely relates to preferable embodiments of the present disclosure and is not intended to limit the present disclosure. For a person skilled in the art, the present disclosure may have various modifications and variations. Any modifications, equivalent replacements, improvements, etc. made within the spirit and principle of the present disclosure shall all belong to the scope of protection of the present disclosure.

What is claimed is:

1. A method for manufacturing a target object, comprising:
acquiring a data file and material property parameters of a printing model, the printing model being a digital three-dimensional model of a target object to be printed;
generating an initial support model and a target finite element model comprising the initial support model according to the data file and the material property parameters;
determining whether the target finite element model satisfies a stress intensity condition;
in cases where the target finite element model does not satisfy the stress intensity condition, adjusting the initial support model in the target finite element model, so that the adjusted target finite element model satisfies the stress intensity condition, to obtain a target support model; performing 3D printing on the printing model according to the target support model; and
in cases where the target finite element model satisfies the stress intensity condition, determining the initial support model as the target support model; performing 3D printing on the printing model according to the target support model.

2. The method for manufacturing the target object as claimed in claim 1, wherein generating the initial support model and the target finite element model comprising the initial support model according to the data file and the material property parameters, comprises:
generating, according to the data file and the material property parameters, a finite element model of the printing model to obtain a first finite element model;
generating a parameterized file of the initial support model according to the data file, the initial support model being a structure supporting the printing model in a printing process;
generating a finite element model of the initial support model according to the parameterized file, to obtain a second finite element model; and
merging the first finite element model and the second finite element model according to the parameterized file, to obtain the target finite element model comprising the initial support model and the printing model.

3. The method for manufacturing the target object as claimed in claim 2, wherein the parameterized file comprises support data corresponding to the three-dimensional model; generating the parameterized file of the initial support model according to the data file, the initial support model being the structure supporting the printing model in the printing process, comprises:
acquiring a three-dimensional model, the three-dimensional model being located in a voxel space formed by an X axis, a Y axis and a Z axis, the voxel space comprising a plurality of voxels;
determining a target source voxel from the plurality of voxels;
determining, in a negative direction of the Z axis, a target secondary voxel corresponding to the target source voxel;
performing voxel type determination on the target secondary voxel to determine a voxel type result of the target secondary voxel; and
obtaining the support data corresponding to the three-dimensional model according to the voxel type result.

4. The method for manufacturing the target object as claimed in claim 3, wherein determining the target source voxel from the plurality of voxels comprises:
acquiring a support point corresponding to the three-dimensional model;
determining a target voxel vertex corresponding to the support point; and
determining, from the plurality of voxels, the target source voxel relating to the target voxel vertex.

5. The method for manufacturing the target object as claimed in claim 3, wherein obtaining the support data corresponding to the three-dimensional model according to the voxel type result, comprises:
determining a next-level voxel according to whether the voxel type result is a blocking voxel type, until a corresponding voxel with a Z coordinate being a baseplate coordinate is determined, so as to obtain the support data corresponding to the three-dimensional model.

6. The method for manufacturing the target object as claimed in claim 5, wherein determining the next-level voxel according to whether the voxel type result is the blocking voxel type, until the corresponding voxel with the Z coordinate being the baseplate coordinate is determined, so as to obtain the support data corresponding to the three-dimensional model, comprises:
in cases where a voxel type of the target secondary voxel is the blocking voxel type, determining a target adjacent voxel corresponding to the target secondary voxel, wherein a Z coordinate of the target adjacent voxel is the same as a Z coordinate of the target secondary voxel; and
determining the next-level voxel by taking the target adjacent voxel as a new source voxel, until the corresponding voxel with the Z coordinate being the baseplate coordinate is determined, so as to obtain the support data, wherein the baseplate coordinate is a minimum coordinate of the three-dimensional model in a direction of the Z axis;
wherein determining the target adjacent voxel corresponding to the target secondary voxel comprises:
determining at least one candidate adjacent voxel corresponding to the target secondary voxel, wherein a Z coordinate of the at least one candidate adjacent voxel is the same as a Z coordinate of the target secondary voxel, and a distance between the at least one candidate adjacent voxel and the target secondary voxel is less than a first predetermined threshold; and
determining the target adjacent voxel from the at least one candidate adjacent voxel.

7. The method for manufacturing the target object as claimed in claim 5, wherein determining the next-level voxel according to whether the voxel type result is the blocking voxel type, until the corresponding voxel with the Z coordinate being the baseplate coordinate is determined, so as to obtain the support data corresponding to the three-dimensional model, comprises:
in cases where the voxel type of the target secondary voxel is not the blocking voxel type, determining a voxel directly below the target secondary voxel as the next-level voxel, until the corresponding voxel with the Z coordinate being the baseplate coordinate is determined, so as to obtain the support data.

8. The method for manufacturing the target object as claimed in claim 5, wherein before determining the next-level voxel according to whether the voxel type result is the blocking voxel type, until the corresponding voxel with the Z coordinate being the baseplate coordinate is determined, so as to obtain the support data corresponding to the three-dimensional model, the method further comprises:
in cases where the support point comprise a support point on an outer surface of the three-dimensional model and a support point on an inner surface of the three-dimensional model, and the baseplate coordinate comprises a first baseplate coordinate and a second baseplate coordinate, determining the first baseplate coordinate corresponding to the support point on the outer surface of the three-dimensional model, and determining the second baseplate coordinate corresponding to the support point on the inner surface of the three-dimensional model, wherein the first baseplate coordinate is a minimum coordinate of the three-dimensional model in a Z-axis direction, and the second baseplate coordinate is a minimum coordinate of an internal hollowed-out portion in the three-dimensional model in the Z-axis direction.

9. The method for manufacturing the target object as claimed in claim 4, wherein determining the target voxel vertex corresponding to the support point comprises:
determining at least one candidate voxel vertex corresponding to the support point, wherein a distance between the candidate voxel vertex and the support point is less than a second predetermined threshold; and
determining the target voxel vertex from the at least one candidate voxel vertex.

10. The method for manufacturing the target object as claimed in claim 9, wherein determining the target voxel vertex from the at least one candidate voxel vertex comprises:
determining the number of supports relating to every one of the at least one candidate voxel vertex is supported; and
determining the target voxel vertex from the at least one candidate voxel vertex according to the number of supports relating to every one of the at least one candidate voxel vertex.

11. The method for manufacturing the target object as claimed in claim 9, wherein determining the target voxel vertex from the at least one candidate voxel vertex comprises:
determining connection parameters for at least one connecting rod connecting the candidate voxel vertex to the support point; and
determining the target voxel vertex from the at least one candidate voxel vertex according to the connection parameters for at least one connecting rod connecting the candidate voxel vertex to the support point.

12. The method for manufacturing the target object as claimed in claim 4, wherein determining, from the plurality of voxels, the target source voxel relating to the target voxel vertex comprises:
determining, from the plurality of voxels, at least one candidate source voxel relating to the target voxel vertex, wherein a Z coordinate of the at least one candidate source voxel is less than or equal to a Z coordinate of the target voxel vertex; and
determining the target source voxel from the at least one candidate source voxel.

13. The method for manufacturing the target object as claimed in claim 4, wherein after determining the target source voxel from the plurality of voxels, the method further comprises:
determining whether a target secondary voxel corresponding to the target source voxel exists in a negative direction of the Z axis; and
in cases where the target secondary voxel corresponding to the target source voxel doesn't exist, determining data of a connecting rod connecting the support point to a predetermined surface.

14. The method for manufacturing the target object as claimed in claim 4, wherein the support point and the target voxel vertex corresponding to the target voxel data are connected to each other by a conical frustum connector, the conical frustum connector comprises a tip and a bottom surface, the tip is connected to the support point, and the bottom surface is connected to the target voxel vertex corresponding to the target voxel data.

15. The method for manufacturing the target object as claimed in claim 2, wherein generating the finite element model of the initial support model according to the parameterized file, to obtain the second finite element model, comprises:
performing division and modeling on the initial support model according to the parameterized file, to obtain the second finite element model.

16. The method for manufacturing the target object as claimed in claim 2, wherein merging the first finite element model and the second finite element model according to the parameterized file, to obtain the target finite element model comprising the initial support model and the printing model, comprises:
determining position coordinates of a connection node between the initial support model and the printing model according to the parameterized file, to obtain contact position coordinates;
determining a polyhedron unit closest to the connection node in the first finite element model according to the contact position coordinates, to obtain a target polyhedron unit;
determining force coupling and transferring of the target polyhedron unit and the second finite element model using a multipoint constraint equation in a finite element method, to obtain an initial finite element model; and
imposing a boundary constraint and a load constraint to the initial finite element model to obtain the target finite element model.

17. The method for manufacturing the target object as claimed in claim 16, wherein determining the polyhedron unit closest to the connection node in the first finite element model according to the contact position coordinates to obtain the target polyhedron unit, comprises:
determining the polyhedron unit closest to the connection node in the first finite element model according to the contact position coordinates and by means of an algorithm for constructing a k-d tree, to obtain the target polyhedron unit.

18. The method for manufacturing the target object as claimed in claim 1, wherein determining whether the target finite element model satisfies the stress intensity condition, comprises:
calculating stresses of all the nodes in the target finite element model to obtain a target stress distribution, and calculating displacement of all the nodes in the target finite element model according to the data file to obtain a target displacement distribution, wherein the displacement comprises a displacement amount of a node of the printing model relative to a corresponding node of the target finite element model, and a displacement amount of a node of the initial support model relative to a corresponding node in the target finite element model; and
determining whether the target finite element model satisfies the stress intensity condition according to the target stress distribution and the target displacement distribution; and in cases where a stress of a node in the target finite element model is less than or equal to a yield stress of a material, determining that the node in the target finite element model satisfies the stress intensity condition.

19. The method for manufacturing the target object as claimed in claim 2, wherein generating, according to the data file and the material property parameters, the finite element model of the printing model to obtain the first finite element model, comprises:
performing meshing on the printing model according to the data file to obtain mesh model data; and
constructing the finite element model of the printing model using polyhedron units according to the mesh model data and the material property parameters, to obtain the first finite element model.

20. The method for manufacturing the target object as claimed in claim 1, wherein adjusting the initial support model in the target finite element model comprises:
adding and deleting connecting rods in the initial support model of the target finite element model according to nodes not satisfying the stress intensity condition in the target finite element model.
